(19) United States
(12) Patent Application Publication
(10) Pub. No.: US 2023/0005385 A1
(43) Pub. Date: Jan. 5, 2023

(54) Literacy Method and System

(71) Applicant: John Zhongqi Wang, Bellevue, WA (US)

(72) Inventor: John Zhongqi Wang, Bellevue, WA (US)

(21) Appl. No.: 17/304,851

(22) Filed: Jun. 27, 2021

(51) Int. Cl. G09B 19/06; G09B 5/06

(52) U.S. Cl. CPC G09B 19/06; G09B 5/06

(57) ABSTRACT

The invention discloses a literacy method and system, and relates to the technical field of computers. A specific implementation of the method includes: displaying a target Chinese literacy interface under a preset trigger condition, and the target Chinese literacy interface includes a main Basic Component of Chinese character or a main Chinese character, which also includes one or more first literacy prompt messages. After the user's selection instruction for the first literacy prompt information is received on the target literacy interface, the target literacy corresponding to the first literacy prompt information selected by the user is displayed under the next-level designated literacy interface, the main Chinese character in the designated literacy interface is derived from the main Basic Component or the main Chinese character of the target literacy interface. This implementation mode enables users to quickly learn and master Chinese characters, realizes the steps and methods for systematically learning Chinese characters, and forms a multi-level system from simple to complex. The interface is simple and easy to use. It can support simplified and traditional characters at the same time. Simply and efficiently display and learn Chinese characters on the screen.

### TECHNICAL FIELD

The present invention relates to the field of computer technology, in particular to a method and system for literacy.

### BACKGROUND TECHNIQUE

There are tens of thousands of Chinese characters, and there are 3,500 commonly used characters. Learning these commonly used characters is a challenge for any learner. The traditional teaching method treats Chinese characters as individuals, learns with the text or learns whatever characters are encountered, there is no systematic procedure and method for learning Chinese characters, there is no multi-level system from simple to complex, is not suitable for large-scale use. The learner does not know what components the Chinese character itself has, nor does it know how it relates to other Chinese characters. In this way, the three elements of shape, sound and meaning of Chinese characters have become isolated things, and both native and non-native language learners find it difficult to learn Chinese characters. In addition, the display of some programs in the existing methods for learning Chinese characters is mostly on the computer screen, which is not suitable for demonstrating and learning a large number of Chinese characters on a small mobile phone screen.

A mobile terminal (such as a mobile phone, etc.) is a tool that modern people usually carry with them. In addition to computers, it is an ideal thing to be able to learn thousands of Chinese characters with mobile phones. Learners can not only see Chinese characters but also hear sounds when using mobile phones to study. However, the size of the display screen of mobile terminals such as mobile phones is limited, usually the size of a palm. The existing literacy solutions cannot simply and efficiently display and learn thousands of commonly used characters based on mobile terminals such as mobile phones.

In the process of implementing the present invention, the inventor found that at least the following problems exist in the prior art:

There is a lack of steps and methods to systematically learn Chinese characters, and a multi-level system from simple to complex has not been formed, therefore not suitable for large scale usage and is difficult to achieve simple and efficient based on mobile terminals such as mobile phones to display and learn thousands of frequently used characters.

### SUMMARY OF THE INVENTION

In view of this, the embodiments of the present invention provide a literacy method and system, which can synthesize the sound, shape, and meaning of Chinese characters from simple characters to complex characters layer by layer, and through the four-direction literacy plane, in the display of the limited size of the mobile terminal, it is demonstrated in a multi-layer plane, so that learners can learn these Chinese characters conveniently while understanding the evolution process and logical relationship of Chinese characters, so as to achieve the purpose of quickly learning and mastering these Chinese characters. The steps and methods for systematically learning Chinese characters are formed, and a multi-level system from simple to complex is formed. The user interface is simple and easy to use, and supports simplified and traditional characters at the same time. It is suitable for a wide range of use and can be used on mobile terminals such as mobile phones to display and learn Chinese characters simply and efficiently on the screen.

To achieve the foregoing objective, according to one aspect of the embodiments of the present invention, a method for literacy is provided.

A literacy method includes: displaying a target literacy interface under a preset trigger condition, the target literacy interface including a main Chinese character Basic Component or a main Chinese character, and also includes one or more first literacy prompt information; in the target literacy character, after the interface receives the user's selection instruction for the first literacy prompt information, it displays the designated literacy interface at the next-level of the target literacy interface corresponding to the first literacy prompt information selected by the user in the designated literacy interface. The main Chinese character in the designated literacy interface is derived from the main Basic Component or the main Chinese character in the target literacy interface.

Optionally, in the case that there is an upper-level literacy interface in the target literacy interface, the target literacy interface includes the main Chinese characters; in the case that the target literacy interface does not have an upper-level literacy interface, the upper-level interface of the target literacy interface is Basic Component selection interface, where the target literacy interface includes a main Basic Component.

Optionally, the main Basic Component in the target literacy interface is a character-forming component or a non-character component, the character-forming component is itself a character, the non-character component is not a character itself, said Basic Component selection interface includes a primary selection interface and a jump selection interface. The primary selection interface is used to select each Basic Component representing the character-forming component category or the non-character component category. The jump selection interface is used to display all of the Basic Components of the character-forming or non-character component category that the selected Basic Component belongs to.

Optionally, the primary selection interface includes character-forming components representing each character-forming component category and a preset symbol, where the preset symbols represent all non-character components which represent the non-character component categories, and when the preset symbol is selected, all non-character components representing the non-character component categories are displayed through the sub-interface of the primary selection interface, and when a non-character component in the sub-interface is selected, it is displayed through a jump selection interface all the Basic Components of the category that the selected non-character component in the sub-interface belongs to.

Optionally, the preset trigger condition is: there is an upper-level literacy interface in the target literacy interface, and in the upper-level literacy interface of the target literacy interface, a second literacy prompt message corresponding to the target literacy interface is selected.

Optionally, the preset trigger condition is: there is no upper-level literacy interface in the target literacy interface, and the Basic Component in the Basic Component select interface which is identical to the main Basic Component in the target literacy interface is selected.

Optionally, the preset trigger condition is: the main Basic Component or the main Chinese character in the target literacy interface matches the content input by the user.

Optionally, the preset trigger condition is that the main Chinese character of a literacy interface that is the same as or different from the designated literacy interface in the next-level literacy interface of the target literacy interface is selected.

Optionally, the first literacy prompt information is a Chinese character component or a Chinese character, and the Chinese character component is based on one or more Basic Components obtained by combining the Chinese character component or Chinese character with the main Basic Component or the main Chinese character in the target literacy interface to derive the main Chinese character in the next-level literacy interface of the target literacy interface.

Optionally, the first literacy prompt information is the same Chinese character as the main Chinese character in the next-level literacy interface of the target literacy interface.

Optionally, the main Basic Component or the main Chinese character in the target literacy interface is located in the central area of the specific space in the target literacy interface, and the first literacy prompt information is located in the peripheral area of the specific space in the target literacy interface.

Optionally, the peripheral area in the target literacy interface includes four sub-areas located in the upper, lower, left, and right directions of the central area in the target literacy interface. The direction of any sub-area relative to the central area of the target literacy interface indicates the direction that the Chinese character component or the Chinese character is added to the main Basic Component or the main Chinese character when deriving the main Chinese character of the next-level specific literacy interface of the target literacy interface. The next-level specific literacy interface is the next-level literacy interface of the target literacy interface corresponding to the first literacy prompt information in the sub-area.

Optionally, the target literacy interface further includes a display area of the character logic information, and the display area of the character logic information is used to display the character logic information of the main Chinese character in the target literacy interface.

Optionally, the display area of the character logic information is located outside the specific space in the target literacy interface.

Optionally, the target literacy interface further includes one or more of the display areas of the meaning information, the display area of the phonetic information, and the display area of the pronunciation control. The display area of the meaning information and the display area of the phonetic information are respectively used to display the meaning information and phonetic information of the main Chinese character in the target literacy interface, and when the pronunciation control is selected, the audio corresponding to the main Basic Component or the main Chinese character in the target literacy interface is issued.

Optionally, one or more of the display areas of the character meaning information, the display area of the phonetic information, and the display area of the pronunciation control are located in the central area of the target literacy interface.

Optionally, the hierarchical relationship between each level of literacy interface is determined according to the derivative relationship of Chinese characters recorded in the Literacy Code table, wherein the Literacy Code table records Basic Components, Chinese characters and the corresponding character identifier, and each Basic Component or Chinese character is located in the layer, the derivation of the Chinese character is represented by the character identifier of each Chinese character in the Literacy Code table and the corresponding character identifier of the upper-layer, and the character identifier of the upper-layer of the Chinese character is derived from the Chinese character Basic Components. The character identifier or the character identifier of other Chinese characters derived from the Chinese character, and the Literacy Code table records the upper-level character identifier of each Chinese character derived from other Chinese characters.

Optionally, the Literacy Code table is generated according to the derivation of Chinese characters in the main literacy path of Chinese characters, wherein the main literacy path of a target Chinese character is determined by the following method: the target Chinese character is gradually split according to the structure of the Chinese character, wherein, from each main path character is selected from the split result of the first step, and the main path character is used for the next split until the final split result is obtained, and the final main path character is selected from the split result of the last step; the target Chinese character and the main path characters at all levels selected during the splitting process are generated according to the reverse order of the splitting order to generate the literacy main path of the target Chinese character.

Optionally, when selecting the main path character based on the splitting results of each step, the selection is made according to the following priority order: Chinese characters or character-forming components are preferentially selected from the splitting result as the main path character. If there is more than one Chinese character or character-forming component in the splitting result, the Chinese character or character-forming component that is the same or similar to the pronunciation of the Chinese character before the splitting in the splitting result is used as the main path character; if there is more than one Chinese character or character-forming component with the same or similar pronunciation of the Chinese character before the split in the split result, the multi-component character in the split result is used as the main path character, and the multi-component character includes multiple components. If there is more than one multi-component character in the splitting result, the multi-component character located on the right, bottom or inside of the Chinese character before splitting in the splitting result is used as the main path character.

Optionally, the Literacy Code table also records the direction of adding Chinese characters or Basic Components from upper-level of Basic Component or the upper-level of Chinese character.

Optionally, according to the direction of adding Chinese characters or adding Basic Components recorded in the Literacy Code table, the direction of the Chinese character or the Chinese character component as the literacy prompt information is determined in the corresponding sub-area of the literacy interface, and the Chinese character component is based on one or more Basic Components.

Optionally, the Literacy Code table also records each Literacy Code corresponding to Basic Component and Chinese character, the Chinese character or Chinese character component as the literacy prompt information is determined according to the Literacy Code.

Optionally, it also includes: for all Basic Components, first, they are divided into two groups according to the character-forming components and non-character components, and then classified according to the shape, and arrange Basic Components according to the set arrangement rules, using different first type alphabets to represent each Basic Component category. Each Basic Component in each Basic Component category is represented by different second type alphabets. The Literacy Code is the combination of the first type of alphabets in the category and the second type of alphabets of the Basic Component.

Optionally, all the Basic Components include Basic Components of Chinese characters for generating simplified characters, traditional characters, Chinese characters in Japanese, and Chinese characters in Korean.

Optionally, in the case that the target literacy interface includes a main Chinese character, when the main Chinese character in the target literacy interface owns a phrase, the target literacy interface further includes a prompt; after the user selects the prompt, the phrase interface corresponding to the main Chinese character of the target literacy interface is displayed, and the main Chinese characters included in the phrase interface are the same as the main Chinese characters in the target literacy interface, so the phrase interface also includes Chinese characters that can be grouped with the main Chinese character in the phrase interface; when one of the Chinese characters that can be grouped with the main Chinese character in the phrase interface is selected, display the phrase interface composed of the selected Chinese character and the main Chinese character of the phrase interface.

Optionally, the prompt is located in the peripheral area of the target literacy interface.

Optionally, the phrase interface has the same layout as the target literacy interface respectively, the Chinese characters that can compose phrase with the main Chinese characters in the phrase interface can be located in the peripheral area in the phrase interface.

Optionally, the Chinese characters that can be grouped with the main Chinese characters of the phrase interface are determined according to a phrase table, and the correspondence between Chinese characters and phrases is recorded in the phrase table.

Optionally, the layout of the literacy interface at different levels is the same.

According to another aspect of the embodiments of the present invention, a literacy system is provided.

A literacy system includes: a display module and a Chinese character derivative module, wherein: the display module is used to display a target literacy interface under a preset trigger condition, and the target literacy interface includes a main Basic Component or the main Chinese character, further including one or more first literacy prompt information; the display module is also used for displaying the first literacy prompt information after the user's selection instruction of the first literacy prompt information is received by the target literacy interface. The selected first literacy prompt information corresponds to the designated literacy interface of the next-level of the target literacy interface, and the main Chinese character in the designated literacy interface is derived from the main Basic Component or the main Chinese character of the target literacy interface in the Chinese character derivative module.

On literacy system specific introduction refer to the embodiment section for the detailed description of each module of the literacy system of the embodiment of the present invention.

According to another aspect of the embodiments of the present invention, a terminal device is provided.

A terminal device includes: a literacy system provided by an embodiment of the present invention.

According to another aspect of the embodiments of the present invention, an electronic device is provided.

An electronic device, comprising: one or more processors; a memory, used to store one or more programs, when the one or more programs are executed by the one or more processors, the one or more multiple processors implement the literacy method provided by the embodiment of the present invention.

According to yet another aspect of the embodiments of the present invention, a computer-readable medium is provided.

A computer-readable medium with a computer program stored thereon, and when the program is executed by a processor, the literacy method provided by the embodiment of the present invention is realized.

An embodiment of the above-mentioned invention has the following advantages or beneficial effects: the target literacy interface is displayed under a preset trigger condition, and the target literacy interface includes the main Basic Component or the main Chinese character, which also includes one or more first literacy prompt messages. After the user's selection instruction for the first literacy prompt information is received on the target literacy interface, the target literacy corresponding to the first literacy prompt information selected by the user is displayed under the next-level designated literacy interface, the main Chinese character in the designated literacy interface is derived from the main Basic Component or the main Chinese character of the target literacy interface. Able to synthesize the sounds, shapes, and meanings of about 4,000 commonly used Chinese characters from simple to complex, layer by layer, and through the four-direction literacy plane in the limited size of mobile terminals (such as mobile phones, etc.). The display is demonstrated in a multi-layered plane, so that learners can learn these Chinese characters conveniently while understanding the evolution process and logical relationship of these Chinese characters, so as to achieve the purpose of quickly learning and mastering these Chinese characters, and realizes the systematic steps and methods of learning Chinese characters in a real way, and the formation of a multi-level system from simple to complex. The user interface is simple and easy to use, and supports simplified and traditional characters at the same time. It is suitable for a wide range of use and can be used on mobile terminals such as mobile phones. Display and learn Chinese characters simply and efficiently.

The further effects of the above-mentioned non-conventional alternative manners will be described below in conjunction with specific implementation manners.

### DESCRIPTION OF THE DRAWINGS

The drawings are used for a better understanding of the present invention, and do not constitute an improper limitation of the present invention. Among them:

FIG. 1 is a schematic diagram of the main steps of a literacy method according to an embodiment of the present invention;

FIG. 2 is a schematic diagram of Basic Component character-forming/non-character codes according to an embodiment of the present invention;

FIG. 3 is a schematic diagram of an example of linear literacy according to an embodiment of the present invention;

FIG. 4 is a schematic diagram of another example of linear literacy according to an embodiment of the present invention;

FIG. 5 is a conceptual diagram of a linear literacy system according to an embodiment of the present invention;

FIG. 6 is a multi-layer binary diagram of Chinese character derivation according to an embodiment of the present invention;

FIG. 7 is a multi-layer bipartite graph derived from Chinese characters according to an embodiment of the present invention;

FIG. 8 is a schematic diagram of a Literacy Code table according to an embodiment of the present invention;

FIG. 9 is a schematic diagram of a basic interface according to an embodiment of the present invention;

FIG. 10 is a conceptual diagram of the hierarchical structure of a literacy system according to an embodiment of the present invention;

FIG. 11 is a schematic diagram of a linear literacy process according to an embodiment of the present invention;

FIG. 12 is a schematic diagram of the entire display process of the linear literacy system from the start interface to the terminal character interface according to an embodiment of the present invention;

FIG. 13 is a schematic diagram of the display process of the non-character component literacy interface of the literacy method according to an embodiment of the present invention;

FIG. 14 is a plane view of some typical characters according to an embodiment of the present invention;

FIG. 15 is a schematic diagram of a linear literacy flow according to an embodiment of the present invention;

FIG. 16 is a schematic diagram of a basic interface according to another embodiment of the present invention;

FIG. 17 is a schematic diagram of the entire display process of the linear literacy system from the start interface to the terminal character interface according to another embodiment of the present invention;

FIG. 18 is a schematic diagram of the contents of a phrase table according to an embodiment of the present invention;

FIG. 19 is a schematic diagram of a phrase recognition process in a literacy system according to an embodiment of the present invention;

FIG. 20 is a schematic diagram of tool tips for Chinese characters or Basic Components according to an embodiment of the present invention;

FIG. 21 is a schematic diagram of auxiliary symbols and functions of Chinese characters or Basic Components according to an embodiment of the present invention;

FIG. 22 is a schematic diagram of main modules of a literacy system according to an embodiment of the present invention;

FIG. 23 is an exemplary system architecture diagram to which the embodiment of the present invention can be applied;

FIG. 24 is a schematic structural diagram of a terminal device of a computer system suitable for implementing embodiments of the present invention.

### DETAILED IMPLEMENTATIONS

The following describes exemplary embodiments of the present invention with reference to the accompanying drawings, which include various details of the embodiments of the present invention to facilitate understanding, and should be regarded as merely exemplary. Therefore, those of ordinary skill in the art should recognize that various changes and modifications can be made to the embodiments described herein without departing from the scope and spirit of the present invention. Likewise, for clarity and conciseness, descriptions of well-known functions and structures are omitted in the following description.

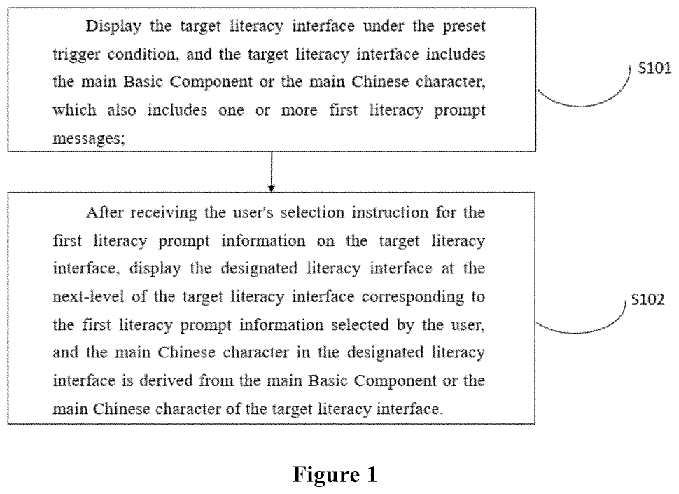

FIG. 1 is a schematic diagram of the main steps of a literacy method according to an embodiment of the present invention.

As shown in FIG. 1, the literacy method of an embodiment of the present invention mainly includes the following steps S101 to S102.

Step S101: Display the target literacy interface under the preset trigger condition, and the target literacy interface includes the main Basic Component or the main Chinese character, which also includes one or more first literacy prompt messages;

Step S102: After receiving the user's selection instruction for the first literacy prompt information on the target literacy interface, display the designated literacy interface at the next-level of the target literacy interface corresponding to the first literacy prompt information selected by the user, and the main Chinese character in the designated literacy interface is derived from the main Basic Component or the main Chinese character of the target literacy interface.

The target literacy interface can be any literacy interface displayed under the preset trigger conditions mentioned above.

The first literacy prompt information is the literacy prompt information in the target literacy interface, and each literacy prompt information in a literacy interface corresponds to a literacy interface in the next-level of the literacy interface. For example, when the user clicks on a certain literacy prompt information, the literacy system of the embodiment of the present invention knows that the literacy prompt information is selected, and then displays a next-level of literacy interface corresponding to the selected literacy prompt information. The designated literacy interface is a literacy interface at the next-level below the target literacy interface corresponding to the first literacy prompt information selected by the user. The function of the literacy prompt information is: the user can select the next character to learn according to the content of the literacy prompt information in the current literacy interface. The next character to be learned is derived from the main Basic Component or the main Chinese character in the current literacy interface and is located at the next-level of the current literacy interface.

The literacy prompt information can be used to combine with the main Basic Component or the main Chinese character of the current literacy interface to derive the next Chinese character to be learned, or the literacy prompt information can be the derivative result of the main Basic Component or main Chinese character in the current literacy interface. We will continue to introduce literacy reminders below.

In the case where there is an upper-level literacy interface in the target literacy interface, the target literacy interface includes the main Chinese character.

In the case that there is no upper-level literacy interface in the target literacy interface, the upper-level interface of the target literacy interface is Basic Component selection interface, the target literacy interface includes main Basic Component.

Subject in the literacy interface, the main Basic Component is a Basic Component to be based on to learn a Chinese character. The main Chinese characters in the literacy interface are the Chinese characters for learning in the literacy interface.

The main Basic Components in the project literacy interface can be a character-forming component or a non-character component. The character-forming component is itself a character, non-character Component is not character itself.

The Basic Component selection interface can include a primary selection interface and a jump selection interface. The primary selection interface is used by the user to select each of the types representing the character-forming component category and the non-character component category. The classification of the Basic Components of Chinese characters will be described in detail below. The jump selection interface is used to display all of the character-forming component categories or non-character component categories of the selected Basic Components in which it is located.

The primary selection interface may include character-forming components representing each character-forming component category and preset symbol. The preset symbol represents all non-character components representing non-character component categories. When the preset literacy is selected, through the primary selection interface, a sub-interface displays all non-character components representing the categories of non-character components. When a non-character component in the sub-interface is selected, a jump selection interface is used to display all the Basic Components of the category that the selected non-character component belongs to in the sub-interface.

The preset trigger condition can be: the upper-level literacy interface exists in the target literacy interface, and in the upper-level literacy interface of the target literacy interface, the second literacy prompt information corresponding to the target literacy interface is selected, and the second literacy prompt information is a literacy prompt message corresponding to the target literacy interface in the upper-level literacy interface of the target literacy interface.

The preset trigger condition can be: there is no upper-level literacy interface in the target literacy interface, and in the Basic Component selection interface, the Basic Component which is identical with the main Basic Component in the target literacy interface is selected.

The preset trigger condition can be: the main Basic Component or the main Chinese character in the target literacy interface match the content entered by the user. For example, the user can enter Basic Component or Chinese character, if the main Basic Component or the main Chinese character in the interface is the same as the content entered by the user, then it is determined that the user needs to learn the main Basic Component or the main Chinese character in the target literacy interface, then display the target literacy interface.

The preset trigger condition may be: the main Chinese character of a literacy interface that is the same as or different from the designated literacy interface in the next-level literacy interface of the target literacy interface is selected.

In one embodiment, the first literacy prompt message may be a Chinese character component or a Chinese character, and the Chinese character component is based on one or more Basic Components obtained, under normal circumstances, the Chinese character component is Basic Component. For some special characters, such as “ [symbol] ”, you need to add two Basic Components to “ [symbol] ” to get the Chinese character, these two added Basic Components can be collectively referred to as Chinese character component. By combining (or synthesis) the Chinese character component or Chinese character as the first literacy prompt message with the main Basic Component or the main Chinese character in the target literacy interface, the main Chinese character in the next-level literacy interface of the target literacy interface is derived.

In another embodiment, the first literacy prompt information may be the same Chinese character as the main Chinese character in the next-level literacy interface of the target literacy interface.

In one embodiment, the Basic Component or the main Chinese character in the target literacy interface can be located in the central area of the specific space in the target literacy interface, and the first literacy prompt information can be located in the peripheral area of the specific space in the target literacy interface. The specific position of the specific space in the literacy interface can be preset as needed.

In one embodiment, the peripheral area in the target literacy interface includes four sub-areas located in the upper, lower, left, and right directions of the central area in the target literacy interface, and the direction of any sub-area relative to the center area in the target literacy interface indicates the direction of adding Basic Component or Chinese character to the main Basic Component or the main Chinese character of the target literacy interface when deriving the main Chinese character of the next-level specific literacy interface of the target literacy interface. The next-level specific literacy interface is the next-level literacy interface of the target literacy interface corresponding to the first literacy prompt information in the sub-area.

In one embodiment, the target literacy interface may further include a display area of the character logic information, and the character logic information display area is used to display the character logic information of the main Chinese character in the target literacy interface.

In one embodiment, the display area of the character logic information is located outside the specific space in the target literacy interface.

In one embodiment, the target literacy interface may also include one or more of the display areas of the meaning information, the display area of phonetic information (for example, the pinyin of Chinese characters), and the display area of the pronunciation control. The display area of the meaning information and the display area of phonetic information are respectively used to display the meaning information and phonetic information of the main Chinese character in the target literacy interface. When the pronunciation control is selected, the audio is produced corresponding to the main Basic Component or the main Chinese character in the target literacy interface.

In one embodiment, one or more of the display areas of the meaning information, the display area of the phonetic information, and the display area of the pronunciation control are located in the central area of the target literacy interface.

In one embodiment, the hierarchical relationship between each level of literacy interface is determined according to the derivative relationship of Chinese characters recorded in the Literacy Code table, where the Literacy Code table records Basic Components, Chinese characters and the corresponding character identifiers, and each Basic Component or Chinese character has its own layer. The derivation relationship of Chinese characters is indicated by the character identifier of each Chinese character in the Literacy Code table and the corresponding character identifier of the upper-layer. The character identifier of the upper-layer of the Chinese character is derived from the Chinese character Basic Component or the character identifier of other Chinese character that the character is derived from. The Literacy Code table records the upper-layer character identifier of each Chinese character derived from other Chinese character.

In one embodiment, the Literacy Code table is generated according to the derivation of Chinese characters in the main literacy path of Chinese characters, wherein the main literacy path of a target Chinese character is determined by the following method: the target Chinese character is gradually split according to the structure of the Chinese character, wherein, each main path character is selected from the split result of the step, and the main path character is used for the next split until the final split result is obtained, and the final main path character is selected from the split result of the last step; the target Chinese character and the main path characters selected in the splitting process at all levels are generated according to the reverse order of the splitting order to generate the main literacy path of the target Chinese character.

In one embodiment, when selecting the main path character based on the splitting result of each step, the selection is made according to the following priority order: Chinese characters or character-forming components are selected first from the splitting result as the main path character; if there is more than one Chinese character or character-forming component in the result, the Chinese character or character-forming component in the split result that has the same or similar pronunciation as the Chinese character before the split is used as the main path character; if the pronunciation of the Chinese characters or the character-forming components is same or similar in the result, the multi-component character will be used as the main path character, and the multi-component character includes multiple (ie two or more) Basic Components. If there is more than one multi-component characters in the splitting result, the multi-component character located on the right, bottom or inside of the Chinese character before splitting in the splitting result will be used as the main path character.

In one embodiment, the Literacy Code table also records the direction that each Chinese character is created by combining upper-level Basic Component with Chinese character or Basic Component, or by combining the upper-level Chinese character with Basic Component or Chinese character.

In one embodiment, according to the direction of adding Chinese characters or adding Basic components recorded in the Literacy Code table, the sub-area of the literacy interface of the literacy interface corresponding to the Chinese character or the Chinese character component in the literacy prompt information is determined. The Chinese character component is based on one or more Basic Components. For example, if a Chinese character is added at the top, the sub-area where the Chinese character as the literacy prompt information is located above the central area.

In one embodiment, the Literacy Code table also records Literacy Code corresponding to each Basic Component and Chinese character, and according to the Literacy Code, the Chinese character or Chinese character component is determined to be the literacy prompt information.

In one embodiment, all Basic Components separate into character-forming components and non-character components first, and then classify them according to shape, and Basic Components are arranged according to the set arrangement rules, using different first type of alphabets to represent each Basic Component category, the Basic Components in each Basic Component category are represented by different second type of alphabets, the Literacy Code is the combining alphabets of the first type of alphabet in the category and the second type of alphabet of the Basic Component. Among them, the two types of alphabets may be English letters, for example, the first type of alphabets are uppercase letters, and the second type of alphabets are lowercase letters, or on the contrary, the present invention does not limit the alphabet form. For the combined alphabets composed of upper and lower case letters above are used to represent Basic Components, the combining alphabets can also be called Basic Component character-forming/non-character code.

All Chinese character Basic Components specifically include Chinese character Basic Components used to generate simplified characters, traditional characters, Chinese characters in Japanese, and Chinese characters in Korean.

In one embodiment, in the case that the target literacy interface includes the main Chinese character, when the target Chinese character in the target literacy interface has a phrase it owns, the target literacy interface also includes a prompt; the target literacy interface receives the user's response to the prompt after the instruction is selected, the phrase interface corresponding to the main Chinese character of the target literacy interface is displayed. The selection instruction for the prompt indicates that the user has selected the prompt. The main Chinese character included in the phrase interface is the same as the main Chinese character in the target literacy interface. The character interface also includes Chinese characters that can be grouped with the main Chinese character of the phrase interface; when one of the Chinese characters which are able to compose phrase with the main Chinese character is selected, the phrase interface for the phrase composed from the selected Chinese character and the main Chinese character is displayed in the phrase interface. The prompt can be a selected form of symbol, alphabet, etc.

In one embodiment, the user can perform the above-mentioned “selected” operations by touching and clicking on the screen or by clicking with a mouse, and the click is usually a single click. In some other embodiments, clicking can also be replaced with actions such as sliding, pressing, double-clicking, etc. The embodiment of the present invention does not limit the specific action mode selected.

In one embodiment, the prompt is located in the peripheral area of the target literacy interface.

In one embodiment, the phrase interface has the same layout as the target literacy interface, and the Chinese characters that can group characters with the main Chinese character of the phrase interface are located in the peripheral area of the phrase interface.

The Chinese characters that can be grouped with the main Chinese characters of the phrase interface can be determined according to the phrase table, and the correspondence between Chinese characters and phrases is recorded in the phrase table.

The layout of the literacy interface at different levels in the embodiment of the present invention is the same.

Chinese characters have been developed step by step in thousands of years of history. People first invented more than two hundred pictographs. These pictographs represent the most common people or things in people's daily life, such as women and the sun, Moon, fire, mountains, etc. Then, these pictographs gradually crossed and combined, then crossed and combined again, and repeated in multiple layers, forming thousands of Chinese characters. Following this trajectory, we can start with primitive pictographic characters and gradually develop a derivation process of Chinese characters from simple to complex. The embodiment of the present invention develops a set of linear literacy methods, namely the literacy method of the embodiment of the present invention, on the basis of the standard and the Basic Component character-forming/non-character code of the proposed in the embodiments of the present invention. Due to the rigor of the standard, the embodiments of the present invention can be strictly applied to four thousand commonly used characters and other characters.

According to the standard “GB13000.1 Character Set Chinese character component Specification for Information Processing” and the attached “Chinese Character Basic Components Table”, 560 Chinese character Basic Components are defined as the basic structure of Chinese characters in a standard way. The 20,902 Chinese characters in the GB13000.1 character set are all composed of these components.

According to the above Chinese character component specification of the embodiment of the present invention, a component is a character structure unit composed of strokes and having the function of assembling Chinese characters. The Basic Component (ie the Basic Component of Chinese characters) is the smallest component that is no longer split, divided into basic character-forming component (itself is a character, referred to as character-forming component) and basic non-character component (not a character itself, referred to as non-character component). Chinese characters can be composed of Basic Components. Analyzing and categorizing the 560 Basic Components will help to use them better.

The Basic Components can be divided into character-forming components and non-character components. If a component is included in the 7,000 Chinese characters in the “Modern Chinese Common Character List”, it is called a character-forming component, otherwise it is called a non-character component. According to this standard, there are 225 character-forming components and 335 non-character components in the Basic Components. Among the non-character components, 215 are used for simplified characters, and extra 120 are used for traditional characters and Japanese and Korean Chinese characters. There are 440 character-forming components and non-character components for simplified characters.

By analyzing the character-forming components and non-character components, it can be known that the character-forming components are generally stretched and full. Since they are all characters themselves, people are more familiar with them, it is very convenient to summarize them together as possible to use them. And among the 225 character-forming components, the following ten components represent the most important physical characteristics of all character-forming components. They are: [symbol] [symbol] . The character-forming components are classified according to the ten characters, and the generated categories are quite characteristic and regular.

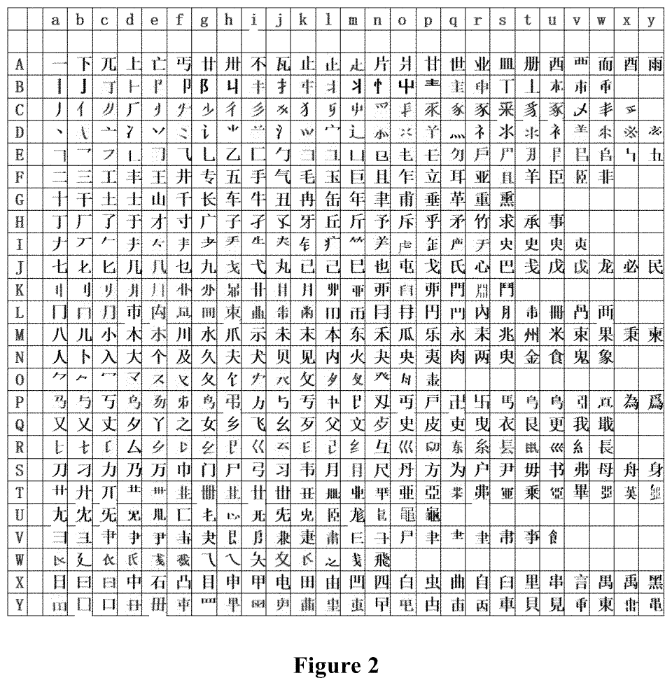

In non-character components, these four (main strokes) components “ [symbol] ”, “ [symbol] ”, “ [symbol] ”, and “ [symbol] ” are very representative, and there are also a dozen non-character components that are very representative in shape. The embodiment of the present invention focuses on the shapes of these non-character components, and the generated categories are also quite different in features and regularity. FIG. 2 shows a schematic diagram of the Basic Component character-forming/non-character code generated by separating character-forming components from non-character components according to an embodiment of the present invention. As shown in FIG. 2, there are a total of 560 Basic Components, including 225 character-forming components and 335 non-character components. Among the non-character components, 120 are only used for traditional characters and Japanese and Korean Chinese characters. All the Basic Components are divided into two components according to their shapes, providing 25 categories (ie, 25 Chinese character Basic Component categories), of which 10 categories are the character-forming component categories, except for a few of those non-character components that are particularly similar to the character-forming components, all others are character-forming components. The remaining 15 are non-character component categories. Except for a few character-forming components that are particularly similar to non-character components, all others are non-character components. Each category occupies a row in FIG. 2, and the first Basic Component of each row along with capital letters is also used to call the Basic Component category. Each Basic Component has a corresponding two-letter string, where the first uppercase letter represents the component category, and the second lowercase letter represents the specific component within the category. For example, the character-forming/non-character code of the component “ [symbol] ” in row J and column d is “Jd”.

In the embodiment of the present invention, a character containing only one Basic Component is called a single-component character, and a character containing two or more Basic Components is called a multi-component character.

Multi-component characters can be divided into left-right structure (for example: [symbol] ), upper and lower structure (for example: “ [symbol] , [symbol] ”), internal and external structure (for example: [symbol] ), and the middle structure (for example: [symbol] ). After some characters have been split into one layer in one structure, they can be split into another structure until they are split into Basic Components. For example, “ [symbol] ” can be split into “ [symbol] ” And “ [symbol] ”, and then “ [symbol] ” can also be divided into “ [symbol] ” and “ [symbol] ” according to the internal and external structure, and finally “ [symbol] ” can also be divided into “ [symbol] ” And “ [symbol] ”.

Since the Basic Component table of the embodiment of the present invention (ie, the Basic Component character-forming/non-character code table of FIG. 2) includes 120 components dedicated to traditional Chinese and Japanese and Korean, the literacy system of the embodiment of the present invention can simultaneously support traditional characters and Chinese characters used in Japanese and Korean.

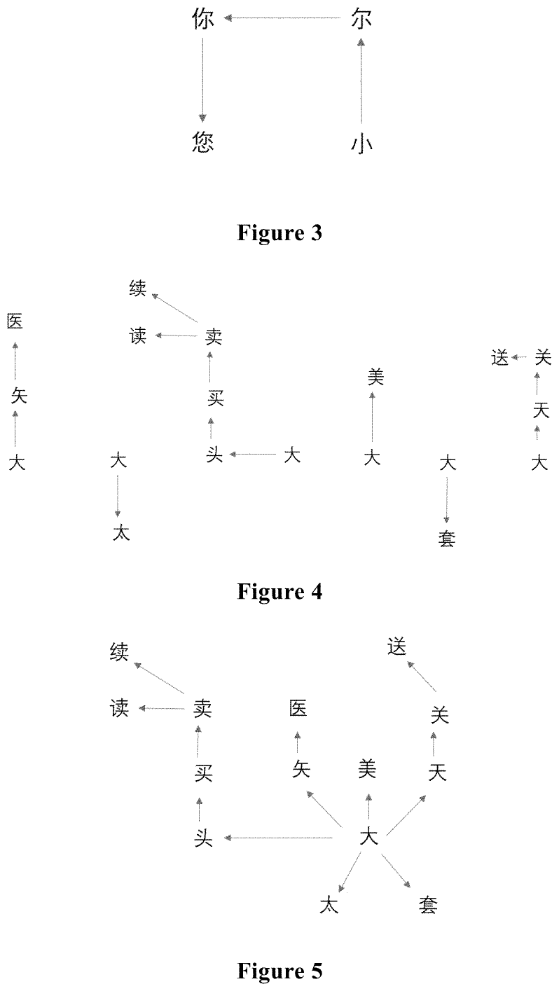

FIG. 3 is a schematic diagram of an example of linear literacy according to an embodiment of the present invention. As shown in FIG. 3, the character “ [symbol] ” has 11 strokes, which looks quite complicated. However, it is developed step by step on the basis of simple characters. The character “ [symbol] ” means things are small, “ [symbol] ” means an arrow. Will “ [symbol] ” added on top of “ [symbol] ” becomes the character “ [symbol] ”, which means that the arrow looks small after being shot out, which means it is far away, which means that the archery skills are superb. Then add “ [symbol] ” to the left of the character “ [symbol] ”, “ [symbol] ” is generated, which represents a person with superb archery skills and is used to call the other party. Add “ [symbol] ” under “ [symbol] ” to form “ [symbol] ”, which means that the name “ [symbol] ” comes out from the “ [symbol] ” to show respect. “ [symbol] ” also borrowed most of the pronunciation of “ [symbol] ”, so the pronunciation is similar to “ [symbol] ”.

In the example of “ [symbol] ”, four points are particularly noticed. The first point, the gradually added shapes like from “ [symbol] ” To “ [symbol] ” to “ [symbol] ” are the Basic Components shown in FIG. 2 and the core of Chinese characters. The scientific nature of the Basic Components of the standard ensures that Basic Components can be added every time instead of may or may not. For this, the existing literacy methods cannot do it. The second point is that basically only one component is added at a time, and it must be added from one of the top, bottom, left, or right directions. There is no other directions for addition. This feature is very clear, namely, the graduality of Chinese characters adding one Basic Component at a time and the linearization of the direction of each adding. The third point is that the process from “ [symbol] ” to “ [symbol] ” is multi-levels, with intermediate generations, many Chinese characters are used. Fourth, some characters not only use the shape and part of the meaning of other characters, but also use part of the pronunciation.

FIG. 4 is a schematic diagram of another example of linear literacy according to an embodiment of the present invention, as shown in FIG. 4, which shows the linear trajectory of multiple characters derived from character “ [symbol] ” in different directions. Like the “ [symbol] ” example, the shapes added when generating a new character in FIG. 4 are the Basic Components of FIG. 2, and each time corresponds to an adding direction. This process is repeated many times. Similarly, the character “ [symbol] ” adopts the pronunciation of the character “ [symbol] ”.

FIG. 5 is a conceptual diagram of a linear literacy system according to an embodiment of the present invention. As shown in FIG. 5, it merges the scattered partial pictures in FIG. 4 together, this invention calls it octopus diagram. In FIG. 5, there is only one “ [symbol] ” character, and all the characters derived from it are connected to it layer by layer from four directions, which vividly shows the appearance of Chinese characters dancing layer by layer in four directions. If you continue to add characters based on this picture, this picture can be expanded into a complete and interrelated derivative trajectory diagram of “ [symbol] ” characters. Applying this example to all Basic Components, you will get all of the characters and linear derivative traces of other characters in four directions. The character literacy system of the embodiment of the present invention can gradually demonstrate such multi-layer Chinese character derivative graphs displaying only one layer at a time.

The character literacy method of the embodiment of the present invention can achieve the effect of effectively and quickly learning Chinese characters. Based on the embodiments of the present invention, first of all, learn Chinese characters in a systematic and scientific manner instead of in isolation. It is easier to learn simple characters first, and then follow the derivative trajectory of Chinese characters to learn more difficult ones layer by layer. Students (that is, learners) know the ins and outs of glyphs and the origins of the meanings and sounds of the characters, and it will be easier for students to recognize and remember the Chinese characters they have learned. The Basic Components and complete Basic Component character-forming/non-character code ensures that this layer-by-layer structure is complete and scientific. However, the prior art literacy based on radicals and similar methods lack complete and systematic Chinese character splitting, therefore they cannot achieve the learning effect of the embodiment of the present invention. Secondly, as a two-dimensional flat text, Chinese characters should be allowed to establish a two-dimensional concept of up, down, left, and right. At the same time, the derivation of Chinese characters at each level must be limited to one direction. This method of being restricted to one direction at a time greatly reduces the difficulty of literacy, so that students only need to pay attention to one direction of a two-dimensional character at a time. The process of converting two-dimensional Chinese characters into one direction at a time is called the process of linearization of planar Chinese characters, and the corresponding system is called a linear system, that is, the literacy system of the embodiment of the present invention. In addition, the Basic Components added in multiple layers generate new Chinese characters layer by layer. This multi-layer process shows that the Chinese characters themselves are integrated, systemic, and interrelated, so that the embodiments of the present invention can be systematically changed from one character to another similar character to learn them. Finally, about half of the characters have roughly the same pronunciation as one of the characters they contain, and the embodiment of the present invention links them together to help literacy. Therefore, the embodiments of the present invention can achieve effects that cannot be achieved by the prior art in terms of reducing the difficulty of learning Chinese characters.

The embodiment of the present invention grasps the Basic Components, the Basic Component character-forming/non-character codes and the linearization of Chinese characters, thereby grasping the core of Chinese character learning. The literacy system based on the literacy method of the embodiment of the present invention can be used as an application system in terminal devices such as mobile phones and computers for students to learn a large number of Chinese characters systematically, efficiently and quickly.

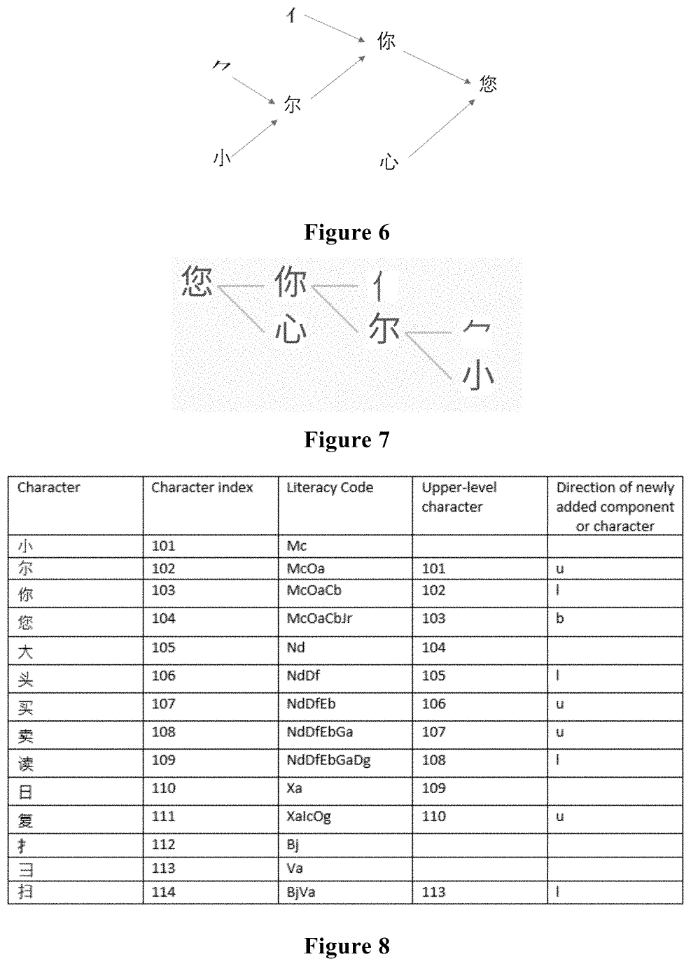

In the schematic diagram of the linear literacy example shown in FIG. 3, the Basic Component “ [symbol] ” is derived to “ [symbol] ”. FIG. 6 is a multi-layer two-to-one diagram derived from Chinese characters according to an embodiment of the present invention, which specifically shows a multi-layer two-to-one diagram derived from the Basic Component “ [symbol] ” to “ [symbol] ”, starting from “ [symbol] ”, requires a combination of “ [symbol] ” and a component to derive “ [symbol] ”, then requires a combination of “ [symbol] ” and a component to derive “ [symbol] ”, and then requires a combination of “ [symbol] ” and a component to derive “ [symbol] ”, and derives each time a new one-level character which is called the derivation process diagram as a multi-layer two-to-one diagram. According to the multi-layer two-to-one diagram of the character “ [symbol] ”, you will find that the character “ [symbol] ” is actually composed of four Basic Components. In the embodiment of the present invention, “ [symbol] ” is selected as the initial Basic Component in the linear graph, and the derivative path from “ [symbol] ” to “ [symbol] ” is selected as the main literacy path, which can be referred to as the main path.

In order to assist the linearization process of the character “ [symbol] ”, FIG. 7 shows a multi-layer bipartite graph of the character “ [symbol] ”. As shown in FIG. 7, the character “ [symbol] ” is not disassembled into Basic Components at once, and is disassembled layer by layer according to the overall structure of the character. Generally, it is disassembled into two Basic Components or characters at a time. In other characters, only characters or Basic Components can be disassembled from each layer. After a character is split into layers, it will always be split into the Basic Components in the end. The character “ [symbol] ” is eventually split into four Basic Components. In order to be more concise and efficient, the linear literacy system (literacy system for short) of the embodiment of the present invention needs to determine one of the four Basic Components as the best literacy path for learning this character. The best literacy path is the implementation of the main literacy path of the present invention. In the multi-layer bipartite graph of FIG. 7, starting from “ [symbol] ”, in the splitting process, determine which branch character or Basic Component belongs to the main path of literacy, and then follow the characters on the main path of literacy until it is determined until the last Basic Component.

Assuming that a character has two direct branch characters or Basic Components, the priority order for determining one of the branch characters or Basic Components belonging to the main path is as follows: the character (ie Chinese character) or the character-forming component is better than the non-character component, under the same conditions as above. The same or similar pronunciation is preferred, and multi-component characters are preferred under the same conditions as above. Under the same conditions as above, if both are multi-component characters, first is located on the right, bottom or inside. Under the same conditions as above, if both of them are non-character components, priority is given to the one with more strokes and stroke order. The following is a specific introduction.

Regarding character or character-forming components, they have higher priority than non-character components. Character-forming components are basically single-body characters. They have strong ability to form characters and are used more frequently. People are most familiar with them. Therefore, try to learn new characters on the basis of character-forming components as much as possible in order to make students feel cordial and relaxed. Similarly, characters are used in people's daily life. People are more familiar with characters than non-character components, which should be more suitable as a basis for learning new characters.

Regarding the same or similar pronunciation, when learning a new character on the basis of a character, if the pronunciation of the basic character is the same or similar to the learned character, it will help to learn the new character. Therefore, among several paths leading to a complex character, if there is a path whose pronunciation is the same as or similar to that of the learned character, the embodiment of the present invention will use this path as the main literacy path to facilitate the user to learn the pronunciation of the character.

Regarding the priority of multi-component characters, if there are two characters, one is a single-component character and the other is a multi-component character, then the multi-component character is selected as the character in the main path of literacy. Multi-component characters are composed of multiple components and often contain more information.

Regarding the priority on the right, bottom or inside, under the same conditions as above, the characters or Basic Components on the right, bottom or inside tend to occupy more space and have a larger effect. Therefore, the characters are preferred as the main path of literacy.

According to the above priority order, the priority order is determined in order when the Chinese characters are split, and a main path of literacy can be determined, thereby determining the learning order of the Chinese characters. For example, in the multi-layer bipartite graph of FIG. 7, starting from “ [symbol] ”, the branch characters or components belonging to the main path are determined level by level, until the final Basic Component. In FIG. 7, “ [symbol] ” is divided into “ [symbol] ” and “ [symbol] ”. The pronunciation of “ [symbol] ” is similar to the pronunciation of “ [symbol] ”, so the character “ [symbol] ” takes precedence and is determined as a character belonging to the main path. The character “ [symbol] ” and its branches can be ignored. Then split “you” into “ [symbol] ” And “ [symbol] ”. Since “ [symbol] ” is a character, it is prioritized as a character belonging to the main path. Finally, “ [symbol] ” is split into “ [symbol] ” and “ [symbol] ”. Since “ [symbol] ” is a character-forming component, it is prioritized as a character belonging to the main path, and it is also the only Basic Component belonging to the main path of literacy in the character “ [symbol] ”. Therefore, the above split sequence is [symbol] . The reverse order of the above splitting order, namely: [symbol] the reverse order of the splitting order is used as the main literacy path, that is, the literacy system of the embodiment of the present invention allows learners to follow [symbol] path for learning.

Chinese characters are a multi-layer planar structure. In order to express a large number of Chinese characters in the literacy system of the embodiment of the present invention for literacy, the embodiment of the present invention uses Basic Components to form a character-forming/non-character code to convert the Chinese character information of the multi-layer planar structure into a linearized Literacy Code that can be understood by the system. The Literacy Code in the embodiment of the present invention is a code that uses the Basic Component character-forming/non-character code contained in a Chinese character to describe the specific shape and derivative trajectory of the Chinese character.

Take the character “ [symbol] ” as an example. According to the introduction above, the main literacy path of the character “ [symbol] ” starts from the character-forming component “ [symbol] ”. Therefore, its Literacy Code also starts from the Basic Component “ [symbol] ”, which is represented by the code “Mc” in the non-character code table of its Basic Components. Note that in the character “ [symbol] ”, “ [symbol] ” is not the starting stroke component. Since “ [symbol] ” is also a character in itself, it is stored in the Literacy Code table of the embodiment of the present invention. The Literacy Code table is shown in FIG. 8, and the character identifier of “ [symbol] ” can be set to “101” in sequence.

The next step is to start from “ [symbol] ” and add “ [symbol] ” to get “ [symbol] ”. Then, add “ [symbol] ” after the Literacy Code of “ [symbol] ” corresponds to the non-character code “Oa”, and obtains the Literacy Code “McOa” of “ [symbol] ”. The Literacy Code of “ [symbol] ” is also stored in the Literacy Code table. In order to show that the character of “ [symbol] ” is in the upper-layer derived on the basis of the character “ [symbol] ”, the character identifier “101” of “ [symbol] ” is recorded in the column of “Upper-level character” in the row of “ [symbol] ”. In order to show that the character “ [symbol] ” is generated by adding Basic Component or character above the upper-level character “ [symbol] ”, in the row of “ [symbol] ”, in the column of “Newly added components or character”, mark “u”, which means that the adding direction is from above. (Similarly, for other examples of adding direction, “b” can be used to represent the bottom, “l” to represent the left (the first letter of left), and “r” to represent the right).

The next step is to add “ [symbol] ” to the left of “ [symbol] ” to get “ [symbol] ”. Then, add corresponding non-character code “Cb” of “ [symbol] ” after the Literacy Code of “ [symbol] ”, you will get the Literacy Code “McOaCb” of “ [symbol] ”. The Literacy Code of the “ [symbol] ” and the left side adding direction “l” and other information are also stored in the Literacy Code table.

The last step is to get “ [symbol] ” from “ [symbol] ” by adding “ [symbol] ” at the bottom. Then add the non-character code “Jr” corresponding to “ [symbol] ” after the Literacy Code of “ [symbol] ” to get the Literacy Code “McOaCbJr” of “ [symbol] ”. The “ [symbol] ” Literacy Code and the direction “b” added below are also stored in the Literacy Code table.

In this way, the linear derivation track from “ [symbol] ” to “ [symbol] ” is recorded through the Literacy Code table of the embodiment of the present invention. The character identifier of each Chinese character in the Literacy Code table and the corresponding upper-layer character identifier indicate the derivation of Chinese characters. That is, which character can be derived from a character, which in turn also reflects the hierarchical relationship between the literacy interfaces of each level (each layer of Chinese characters has its own interface level). In the linear literacy system of the embodiment of the present invention, the relevant Chinese characters will be learned along the linear derived trajectory and information recorded in the Literacy Code table.

The Literacy Code table shown in FIG. 8 also lists the Literacy Codes of some other example characters. For example, there are no other characters between “ [symbol] ” and “ [symbol] ” that can be generated. The “ [symbol] ” character directly adds two Basic Components on the basis of “ [symbol] ” to generate the Literacy Code “XaIcOg” of “ [symbol] ”. The order of the Basic Components is in accordance with the order of the main path, and the adding direction of the corresponding “ [symbol] ” record in the Literacy Code table is the adding direction of the first Basic Component or character added.

The character identifier corresponding to “112” and “113” in the Literacy Code table shown in FIG. 8 are two non-character components. The two non-character components can form a “ [symbol] ”. The character identifier of “ [symbol] ” is “114”, and the Literacy Code is “BjVa”.

By adding four thousand commonly used characters to the Literacy Code table of the embodiment of the present invention according to the above method, the complete character-forming/non-character Literacy Code required by the linear literacy system, referred to as the Literacy Code, and the Literacy Code for one character is obtained, where each of its Basic Components has its own character-forming/non-character code.

The embodiment of the present invention realizes the literacy process through a multi-level interface.

In order to display four thousand or more commonly used Chinese characters on a limited mobile phone screen and allow students to learn conveniently, the user interface of the linear literacy method of the embodiment of the present invention meets the following conditions:

Able to express the shape, pronunciation and meaning of each character.

It can express the derivation relationship between a character and the directly generated character and the direction of adding Basic Components. Such as “ [symbol] ” plus “ [symbol] ” generate “ [symbol] ” and “ [symbol] ” is added to the left of “ [symbol] ”.

It can express the relationship between a character and the characters in its layer, such as “ [symbol] ” and “ [symbol] ” (passing through the “ [symbol] ” layer).

There is space to express the relationship between a character and more than twenty directly generated characters, and the size of the character is large enough.

There is room to express the rationale for the generation of a character. For example, “ [symbol] ” represents a person who excels in archery.

Can easily convert from one character to another. The interface can support more than four thousand characters.

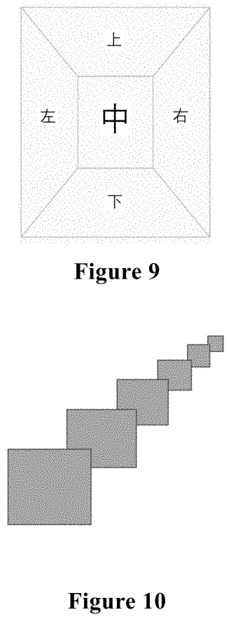

FIG. 9 is a schematic diagram of a basic interface dedicated to satisfying the above goals in an embodiment of the present invention. As shown in FIG. 9, the basic interface is a specific space in the literacy interface of the embodiment of the present invention. It has a central space (or central area) surrounded by 4 enclosed spaces (or 4 sub-areas of the surrounding area) up, down, left and right, as shown in FIG. 9, each sub-area is a trapezoid, the central area is a square or rectangle. The central area is used to express the character currently being learned (ie the main Chinese character or the main Basic Component), in this example, because “ [symbol] ” is a Basic Component, so it is called the main Basic Component of the literacy interface, which is a character-forming component, that is, it is a character by itself, and is located in the central space, so it can also be called a central character. It should be noted that the main Chinese character of a literacy interface is located in the central area and can also be called a central character. The surrounding four enclosed spaces are used to display Basic Components or characters that can form new characters with the center character. In addition, the directions of up, down, left, and right represent the directional relationship between these Basic Components or characters and the center character. When the user selects a Basic Component or character in the enclosed space around, the literacy system of the embodiment of the present invention merges the component or character selected by the user and the central character into a new character (that is, the next layer character derived from the central character), and will be redisplayed to the user as the content centered on the new character. In this way, the central character is connected with the Basic Components or characters around them.

It should be noted that the space in the peripheral area of the embodiment of the present invention may not be closed, as long as it can indicate the up, down, left, and right directions of the central area. For example, the peripheral area can be arranged above the central area, down, left, right and up, but do not connect with each other. For another example, the surrounding area can be laid out in a separate space area around the central area, and divided into four sub-areas. The layout of the four sub-areas is up, down, left, and right. The present invention does not limit this.

FIG. 10 is a conceptual diagram of the hierarchical structure of the character literacy system according to an embodiment of the present invention, which expresses the hierarchical relationship from simple characters to complex characters. Each size of plane in this FIG. 10 is a literacy interface displayed at the same position on the screen at different times, that is, only one plane is displayed at a time, but the content of each time changes with the content of the center character. It should be noted that the size relationship of the planes in FIG. 10 does not represent the size relationship of the literacy interface of the embodiment of the present invention, and the literacy interfaces of the embodiment of the present invention may have the same size. The literacy method of the embodiment of the present invention provides a system interface that walks between characters in various layers, and so on, layer by layer, and so on, until the terminal layer (that is, the last layer, that is, there are no Chinese characters that can be generated). When the user clicks on a character in the central space of a certain literacy interface, the literacy interface will return to the content of the center character of the previous layer, and so on, until it returns to the starting layer (ie the first layer of literacy interface). In the embodiment of the present invention, in addition to displaying the content in the plane as shown in FIG. 10 in the literacy interface, information such as character logic (that is, the rationale of the character) may also be displayed under the area where the content is displayed. Each of the more than four thousand characters (the number of characters in the embodiment of the present invention is not limited to four thousands) has a corresponding plane view centered on the character.

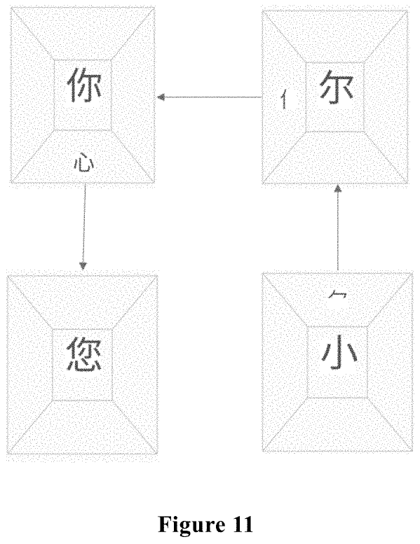

FIG. 11 is a schematic diagram of a linear literacy process according to an embodiment of the present invention. FIG. 11 takes “ [symbol] ” to “ [symbol] ” as an example to demonstrate the basic interface of each level of literacy interface from “ [symbol] ” to “ [symbol] ” (ie, the literacy interface) specific space in). For clarity, other related characters and Basic Components are not shown in FIG. 11. FIG. 11 demonstrates that “ [symbol] ” can be clicked on the top “ [symbol] ” to generate the center character “ [symbol] ” of the next layer plane, click on “ [symbol] ” from the left side of the character “ [symbol] ”, you can generate the center character “ [symbol] ” in the next layer plane, and click “ [symbol] ” below the character “ [symbol] ” to generate the center character “ [symbol] ” in the last layer plane. Each layer plane corresponds to a specific space in the literacy interface. For each character in the plane view shown in the plane, the character's literacy interface (that is, the literacy interface with the character as the main Chinese character or the main Basic Component) can display the meaning, pinyin and pronunciation horn symbols of the character in order to facilitate learning. Below a specific area in the literacy interface (not shown in FIG. 11), you can also indicate the formation logic of the character. For the characters in the border (that is, the characters in the enclosed space or the sub-area of the surrounding area), only marks pinyin.

By displaying all four thousand commonly used characters in the linear literacy system of the embodiment of the present invention according to the Literacy Code and the above method, the student has a complete set of Chinese character learning system. The linear literacy system of one embodiment of the present invention can display the sound and meaning of Chinese characters and the derivation of fonts in four directions layer by layer with thousands of Chinese characters on a limited mobile phone screen, so that students can learn, study and roam Chinese characters efficiently and conveniently.

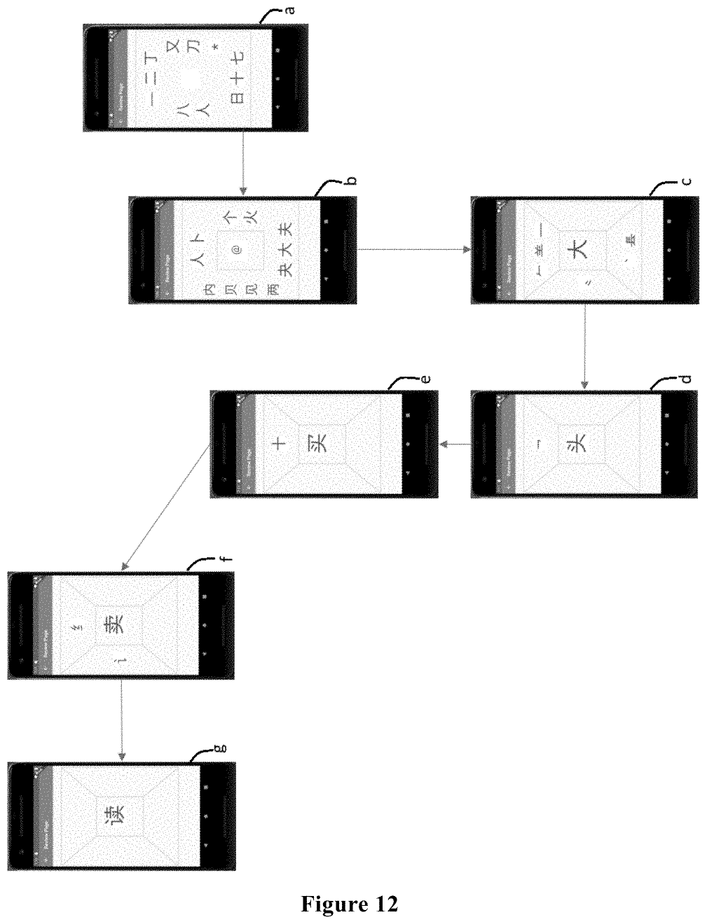

FIG. 12 shows a schematic diagram of the entire display process from the initial interface to the terminal character interface of the linear literacy system according to an embodiment of the present invention. FIG. 12 includes sub-figures a to g, where sub-figure a is the initial interface of the linear literacy system according to the embodiment of the present invention, that is, the primary selection interface. As the initial interface of the system, it displays 10 character-forming component categories and a non-character component category representative symbol “*” in the Basic Component categories of Chinese characters for users (ie learners) to choose. The non-character component category representative symbol “*” is a preset symbol representing all the non-character components that represent the category of non-character components. The entire interface of FIG. 12 shows only one frame.

The Basic Components of Chinese characters shown in sub-figure a of FIG. 12 are the character-forming components representing each character-forming component category. When the user clicks on one of the character-forming component categories listed in FIG. 12 in the initial interface of sub-figure a (that is, when one of the character-forming components is clicked), the system will display the Basic Components of the category. Take the Basic Component category “ [symbol] ” as an example. When the user clicks on “ [symbol] ” in sub-figure a, the system enters the “ [symbol] ” Basic Component category shown in sub-figure b. Sub-figure b is an example of a jump selection interface. For this example, all the Basic Components of the category “ [symbol] ” displayed to the user, that is, all the Basic Components of the row of “ [symbol] ” in the Literacy Code table of the embodiment of the present invention. All Basic Components in the category of “ [symbol] ” can be listed in the surrounding box for users to choose. There is no dividing line in the surrounding border. The surrounding border refers to the area around the center area of the jump selection interface, and the center area of the jump selection interface and the center area of the literacy interface can be located at the same position on the screen. Since there is no affiliation between the Basic Components, there is no connection between the positions of the Basic Components in the surrounding frame in this layer. The sub-figure b shows some Basic Components such as [symbol] , and “ [symbol] ” belonging to this category. “@” is displayed in the center area of the subfigure b to indicate that this interface is a Basic Component category interface. There is no central character, which is different from the literacy interface. The Basic Component category interface is an example of a jump selection interface in the embodiment of the present invention.

When the user clicks on a Basic Component listed in the Basic Component category interface of “ [symbol] ” in sub-figure b, the literacy system (referred to as the system) of the embodiment of the present invention will display the Basic Component, with the Basic Component “ [symbol] ” taking for example. When the student clicks “ [symbol] ” in sub-figure b, the system enters the literacy interface centered on the Basic Component “ [symbol] ” shown in sub-figure c. It can be seen from sub-figure c that “ [symbol] ” is the main Chinese character Basic Component of the literacy interface, which is a character itself, is located in the central area. The main Chinese character Basic Component of a literacy interface is a character itself, and the character can also be called a basic character.

The interface from sub-figure d to sub-figure g is also a literacy interface. Different from the literacy interface in sub-figure b, the characters in the central area of the literacy interface from sub-figure d to sub-figure g are not basic Chinese characters. The characters located in the central area of the literacy interface of sub-figure d to sub-figure g are called the main Chinese characters of the corresponding literacy interface. Compared with the basic characters, the main Chinese characters can be called general characters.

There is no difference in layout between the basic character-centric literacy interface and the general character-centric literacy interface. Click on a character or Basic Component in the area surrounding the central area, and the system will redisplay a new literacy interface. The central character of the new literacy interface is formed by merging the clicked character or component and the central character when clicked.

Sub-figure c is the first-level literacy interface. Assuming that the literacy interface of this sub-figure c is used as the target literacy interface, since there is no upper-level literacy interface, then when Basic Component “ [symbol] ” in the selection interface (for example, sub-figure b) is selected, the literacy interface of “ [symbol] ” in sub-figure c is displayed. That is: there is no upper-level literacy interface in the target literacy interface, and the identical Basic Component in the base component selection interface with the main Basic Component in the target literacy interface being selected is a trigger condition for the display of the target literacy interface.

For example, when the user clicks “ [symbol] ” in the area on the left of the center area in the literacy interface with “ [symbol] ” as the center character in sub-figure c, the system enters the literacy interface with “ [symbol] ” as the center character shown in sub-figure d. “ [symbol] ” is composed of the central character “ [symbol] ” plus the component “ [symbol] ” synthetic. For brevity, no other components or characters are displayed in the surrounding box of sub-figure d. Assuming that sub-figure d is the target literacy interface, then for this example, there is an upper-level literacy interface in the target literacy interface, and in the upper-level literacy interface in the target interface, the second literacy prompt information corresponding to the target literacy interface (in this example, “ [symbol] ”) is selected, which is a trigger condition for the display of the target literacy interface.

When the user clicks on the upper “ [symbol] ” on the literacy interface of sub-figure d with “ [symbol] ” as the center character, the system enters the literacy interface with “ [symbol] ” as the central character shown in sub-figure e. “ [symbol] ” is the central character “ [symbol] ” with Basic Component “ [symbol] ” added to the top to be synthesized.

When the user clicks the upper “ [symbol] ” on the literacy interface with “ [symbol] ” as the center character in sub-figure e, the system enters the literacy interface with “ [symbol] ” as the center character shown in sub-figure f. “ [symbol] ” is synthesized by adding the Basic Component “ [symbol] ” to the top of the center character “ [symbol] ”.

When the user clicks on the left “ [symbol] ” on the literacy interface centered on “ [symbol] ” in sub-figure f, the system enters the literacy interface with “ [symbol] ” as the center character shown in sub-figure g. “ [symbol] ” means adding Basic Component “ [symbol] ” to the left from the center character [symbol] has no next-level characters here, so it is called terminal character. The literacy interface where the terminal characters are located does not have a corresponding next-level literacy interface.

Between sub-figure b and sub-figure g, for the interface in any sub-figure, clicking the center character will return to the interface of the previous layer. For example, if the current interface is the interface corresponding to subfigure c, then when the user clicks “ [symbol] ” in sub-figure c, the interface displayed to the user will be changed from the literacy interface corresponding to sub-figure c to the interface corresponding to sub-figure b (jump selection interface). If the current interface is the interface corresponding to sub-figure d, if the user clicks on the “ [symbol] ” in sub-figure d, the interface corresponding to sub-figure c will be displayed to the user accordingly.

The Basic Components or characters used to synthesize new characters with the current literacy interface are literacy prompt information. In this example, the characters or Basic Components in the area around the central area are called literacy prompt information, such as “ [symbol] ” is a literacy reminder.

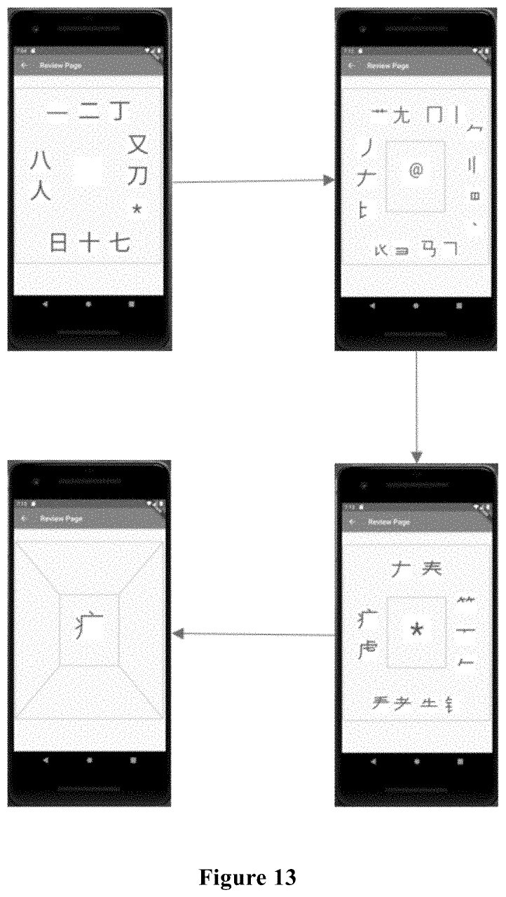

FIG. 13 is a schematic diagram of the display process of the non-character component literacy interface of the literacy method according to an embodiment of the present invention. The non-character component literacy interface is a literacy interface where its main Basic Component is a non-character component, that is, it is not a character itself. If the user clicks the non-character component category representative symbol “*” in FIG. 13, similar to FIG. 12 process of character-forming components as the main Basic Component, FIG. 13 shows from “*”→all 15 categories of non-character components→non-character components category “ [symbol] ”→non-character component “ [symbol] ”. This display process is based on the direction of the arrow in FIG. 13. After the user clicks the “*” in the first sub-figure, the interface in the second sub-figure will be displayed (an example of the sub-interface of the primary selection interface). It includes all 15 categories of non-character Basic Components, which are displayed in the interface of the second sub-figure. It is a non-character component that represents each non-character component category. When the user clicks “ [symbol] ”, the third sub-figure is displayed, which is the Basic Components in the row “ [symbol] ” of Literacy Code table, the third sub-figure only shows the Basic Components of row “ [symbol] ”. In the actual implementation, you can display all of the Basic Components of row “ [symbol] ” of the Literacy Code table in the surrounding area of the central area where “*” is located.

Through the interface of the linear literacy system of the embodiment of the present invention, the user can easily learn more than four thousand related Chinese characters.

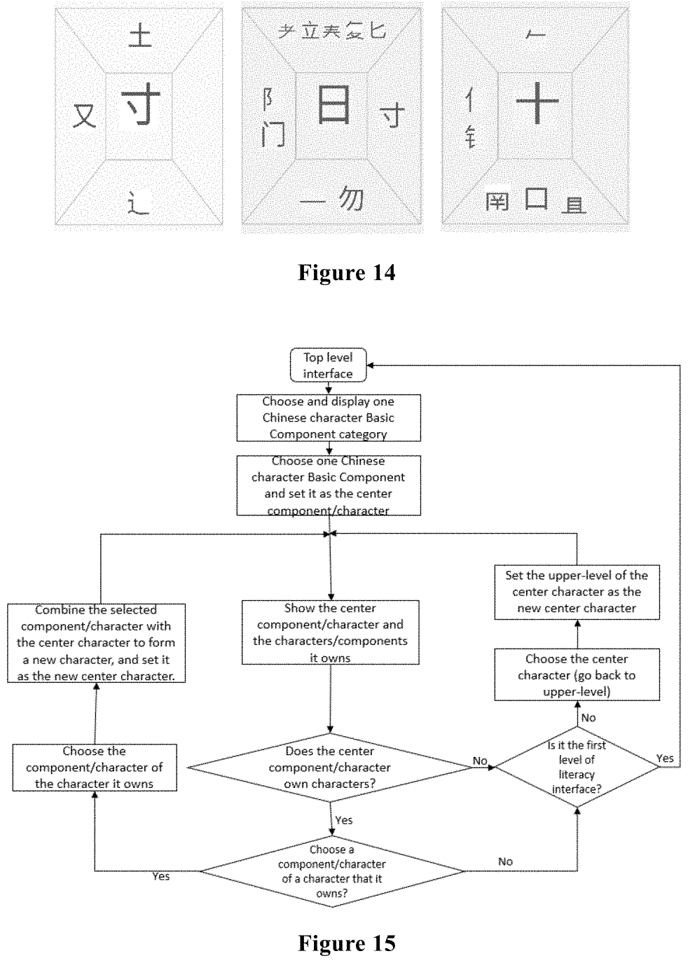

FIG. 14 is a plane view of some typical characters according to an embodiment of the present invention. In FIG. 14, the middle character (that is, the center character) plus the Basic Components or characters next to it (that is, the surrounding area) can form a new character. For example, in the first plane view in FIG. 14, the center character “ [symbol] ” plus the Basic Component “ [symbol] ” on the left area in the surrounding area can generate the character “ [symbol] ”. Sometimes the center character needs to be added more than one Basic Components at a time in order to form a new character, then it can be in the border (ie the surrounding area) simultaneous display of multiple Chinese character Basic Components added, such as the character “ [symbol] ” in the second plane view of FIG. 14, adding two Basic Components at the same time on the basis of the central character “ [symbol] ”, then you can directly display the two Basic Components added at the same time. Since the directions of adding two components on the basis of “ [symbol] ” are up and down, when determining the sub-area where the “ [symbol] ” is located, the direction of the first Basic Component added can be used to determine the sub-area. For example, the first Basic Component added is added above the “ [symbol] ”, then two Basic Components that should be added at the same time are displayed in a sub-area above the center area in the surrounding area.

FIG. 15 is a schematic diagram of a linear literacy process according to an embodiment of the present invention. As shown in FIG. 15, in an embodiment of the present invention, a user can enter the literacy system of the embodiment of the present invention from the top-level interface. The literacy system displays the top-level interface. The top-level interface is the initial interface of the linear literacy system, that is, the primary selection interface. Based on the user's selection of the Basic Component category in the start interface (Users can click on the icon representing the character-forming component category or non-character component category in the initial interface to choose Basic Component category) to display all the Basic Components for the Basic Component category selected by the user, then when user select a Basic Component, display the Basic Component as the central component or central character of the literacy interface. Among them, the central character refers to the Chinese character located in the central space of the literacy interface and which is itself a character-forming component, and the central component refers to the non-character component located in the central space. Through the literacy interface, the central component or the central character and the character or component to which it belongs are displayed. The central component or the central character and the character or component to which it belongs can be combined with the central component or central character to derive a new character. Determine whether the currently displayed central component or central character has direct subordinate characters. Direct subordinate characters are characters derived from the central component or central character. If the currently displayed central component or central character has a direct subordinate character, it is further judged whether to select a direct subordinate character component or character, if so, select a direct subordinate character component or character according to the user's instruction, and according to the selection, the component or character is combined with the corresponding central component or central character to synthesize a new character (ie the corresponding direct character), and the new character is displayed on the literacy interface. The new character is set as the central character of the new literacy interface, and then jump to the above steps of displaying the central component or central character and the characters or components belonged to it through the literacy interface.

If the above judgment result of judging whether the currently displayed central component or central character has a directly subordinate character is no, then it is further judged whether the interface of the central component or central character is the first-level literacy interface, if not the first-level literacy interface, according to the user's selection instruction for the center component or center character (the selection instruction can be obtained based on the user clicking the center component or center character), the previous level of literacy interface is displayed, and the center component or center character set the upper-level component or character as the new central component or central character of the upper-level literacy interface, and then jump to the step of displaying the central component or central character and the characters or components belonged to it through the literacy interface.

If the judgment result of judging whether the interface of the central component or the central character is the first-level literacy interface is yes, then according to the user's selection instruction for the central component or central character (the selection instruction may be based on the user clicking the central component or the center character), the interface of the previous level is displayed, and the interface of the previous level displayed at this time is the interface of the Basic Component category, such as sub-figure b in FIG. 12. When the user further clicks on the central area “@”, then it further returns to the top-level interface.

The Literacy Code table in the embodiment of the present invention can be used to determine whether the central component or the central character has a direct character. Take the Literacy Code table in FIG. 8 as an example. The fourth column in FIG. 8 is “Upper Level Characters”. For example, the upper-level character column of “ [symbol] ” records the character identifier of “ [symbol] ”, which can be judged that the upper-level character of “ [symbol] ” is “ [symbol] ”, not “ [symbol] ”. Similarly, it can be judged that the upper-level character of “ [symbol] ” is “ [symbol] ”. Through each Basic component in Literacy Code table or the upper-level character identifier corresponding to the Chinese character, directly subordinate characters of the Basic Components or Chinese characters can be determined. In addition, for the convenience of users, in the interface display, the various components of the Chinese characters can be distinguished by color during display. For example, the character “ [symbol] ” in the surrounding frame can be displayed in two colors. Some components are in the same color as the center character “ [symbol] ”, and the other components are displayed in another color.

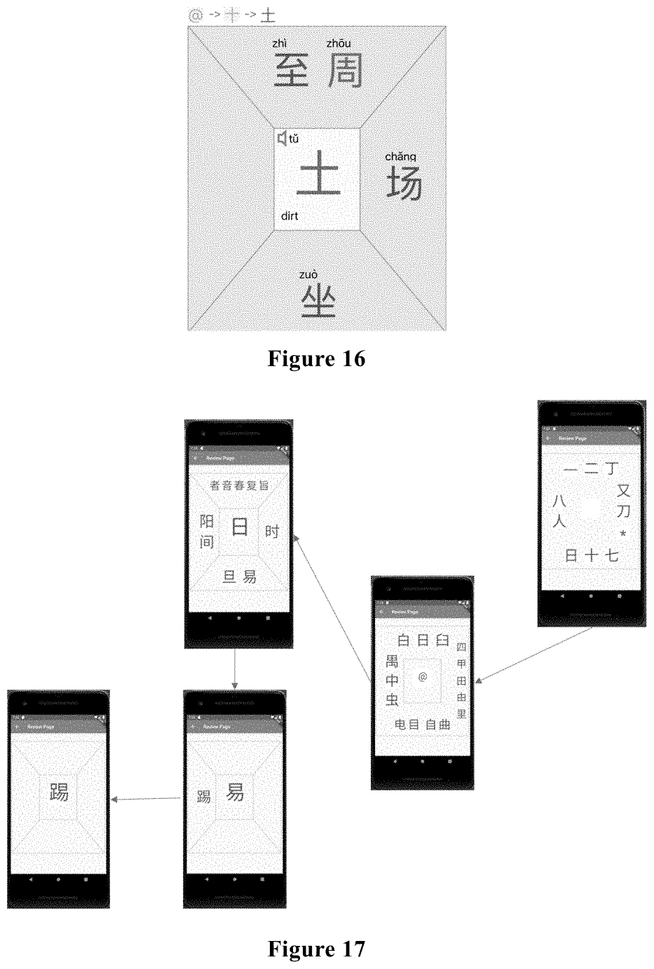

FIG. 16 is a schematic diagram of a basic interface according to another embodiment of the present invention. As shown in FIG. 16, this embodiment is a multi-layer example of a whole-character linear literacy system, that is, new Chinese characters derived from the central character are directly displayed in the surrounding area. For example, the central character is “ [symbol] ”, and [symbol] , etc. can be derived from “ [symbol] ”, (FIG. 16 does not show all the derivative characters of “ [symbol] ”), then you can directly displays these complete characters derived from “ [symbol] ” in the surrounding area instead of displaying the Basic Components or characters used to combine with “ [symbol] ”. Assuming that the literacy interface with the central character “ [symbol] ” is used as the target literacy interface, then [symbol] , etc. in this example are the first literacy prompt information, which are the interface with the target literacy. The main Chinese characters in the next-level literacy interface are the same Chinese characters. When the user clicks on one of the characters in the surrounding area, the literacy interface where the selected character (that is, the clicked character) is displayed, for example, if the user selects “ [symbol] ”, the literacy interface where the “ [symbol] ” is located is displayed to the user, “ [symbol] ” is the central character in the new literacy interface displayed. This kind of literacy interface is very convenient for comparing the pinyin of the center character and the character located in the surrounding area. The other components of the literacy system remain unchanged. “@-> [symbol] ” is displayed at the top of the box in FIG. 16 to remind the user where the current character “ [symbol] ” is in the literacy system.

FIG. 17 is a schematic diagram of the entire display process from the start interface to the terminal character interface of the linear literacy system according to another embodiment of the present invention. As shown in FIG. 17, the entire display process is similar to that of FIG. 12, except that in the literacy interface at all levels, the peripheral area displayed in the surrounding area is derived from the central character, for example, in the central character “ [symbol] ”. The surrounding area of the central area where “ [symbol] ” is located is the derivative of “ [symbol] ”. After the user selects (by clicking, etc.) a Chinese character, such as “ [symbol] ”, the next-level of the literacy interface where “ [symbol] ” is displayed will be displayed. “ [symbol] ” corresponds to the literacy interface, and the central character in the newly displayed literacy interface is “ [symbol] ”. FIG. 17 shows a complete process of displaying such a complete process from the top level interface→the Basic Component category of “ [symbol] ”→the Basic Component itself of “ [symbol] ”→“ [symbol] ” according to user instructions.

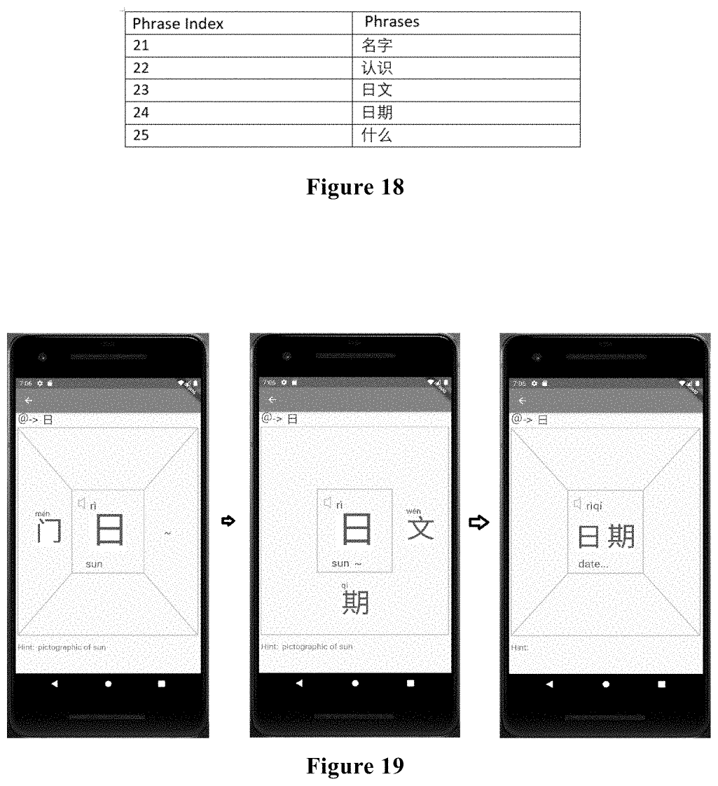

An embodiment of the present invention can connect phrases into a linear literacy system like a combined character (including multiple Basic Components), which will be described in detail below. FIG. 18 is a schematic diagram of the content of a phrase table according to an embodiment of the present invention, in which part of the phrases supported in the literacy system of the embodiment of the present invention are exemplarily listed, and each line contains phrase numbers and phrases. FIG. 19 is a schematic diagram of a phrase recognition process in a character recognition system according to an embodiment of the present invention.

In the literacy interface shown in the first sub-figure in FIG. 19, the symbol “˜” is the prompt, which indicates that the character “ [symbol] ” contains phrases. After the user clicks the prompt “˜”, the system receives the user's instruction to select the prompt, and will search the phrase table to find phrases that include “ [symbol] ”, and then determine the characters that can be combined with the character “ [symbol] ”. For Chinese characters, the determined Chinese characters can be displayed in the phrase interface shown in the second sub-figure of FIG. 19 regardless of order and direction. In the phrase interface shown in the second sub-figure of FIG. 19, there is a “˜” symbol after the character “ [symbol] ” in the phrase interface, which is used to remind the user that the user is currently in the phrase interface. When the user clicks on the Chinese character “ [symbol] ” in the second sub-figure of FIG. 19 that the user wants to generate phrases, the system determines that the phrase generation of “ [symbol] ” is selected, and the phrase interface shown in the third sub-figure of FIG. 19 will be displayed. The interface contains specific information for the phrase “ [symbol] ”. Like a plane view of a character, the phrase interface of the embodiment of the present invention can display pinyin, character meaning, prompts, and so on.

For learners, the process of the literacy system of the embodiment of the present invention is very simple. After entering the literacy interface of a Basic Component from the Basic Component category interface, according to the user's choice, for any Basic Component or character in the selected peripheral frame, the center character and the character in the selected peripheral frame will be merged into a new one. Then, the content of the interface displayed to the user will be updated to a literacy interface centered on the new character. If the user selects the components or characters on the peripheral border of the literacy interface with the new character as the center character, the user continues to enter the literacy interface of the next-level, and so on, until the literacy interface where the terminal character is displayed. In any literacy interface, when the user selects the Basic Component or character in the central area (ie the Basic Component of the main Chinese character or the main Chinese character), the system will return to the previous level of interface according to the user's selection instruction.

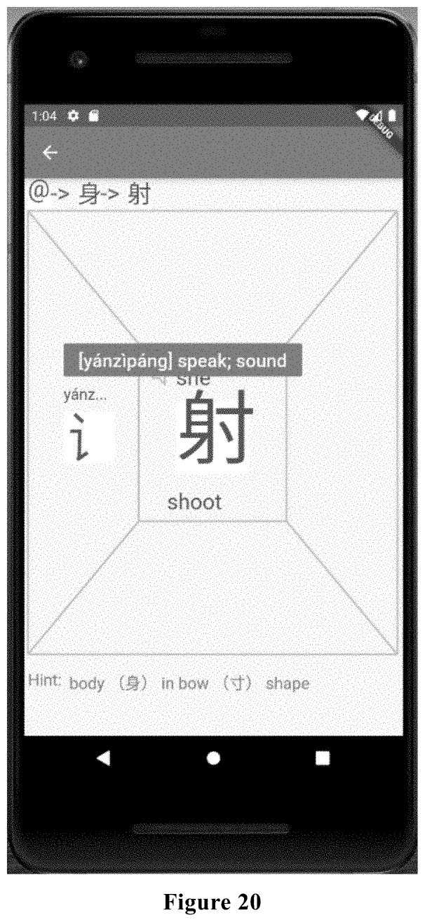

FIG. 20 shows a schematic diagram of tool tips for Chinese characters or Basic Components according to an embodiment of the present invention. In the literacy interface of an embodiment of the present invention, when it is detected that a mouse or finger rests on a character or Basic Component (but does not press, specifically, when the finger stays on a character or the Basic Component for a period of time of the preset time threshold, it is judged as stay, not pressed), no matter where the character or Basic Component is located in the central area or the surrounding area, the system will display the tooltip of the character or the Basic Component. The prompt content includes but not limited to the pinyin and meaning of the character or Basic Component, as shown in FIG. 20. As shown, the terminal device is a mobile phone as an example. When it is detected that the user's finger is placed on “ [symbol] ”, a tool tip above “ [symbol] ” will be displayed with the prompt content such as the pinyin of “ [symbol] ” and the meaning of the character. In this example, the meaning of the character is the meaning of the character expressed in English, the meaning of the character in the embodiment of the present invention may be in other languages, and is not limited to English.

It should be noted that, for the phrase grouping interface or phrase interface of the embodiment of the present invention, the present invention may also have similar functions as shown in FIG. 20. For example, for the phrase grouping interface, when a mouse or finger is detected on a character (but not pressed), no matter if the character is the center character or a character that can be grouped with the center character, the tooltip of the character can be displayed, and the prompt content includes but not limited to the pinyin and meaning of the character. For the phrase interface, when a mouse or finger is detected on a phrase (but not pressed), a tool tip of the phrase is displayed. The prompt content includes but is not limited to the pinyin and meaning of the phrase.

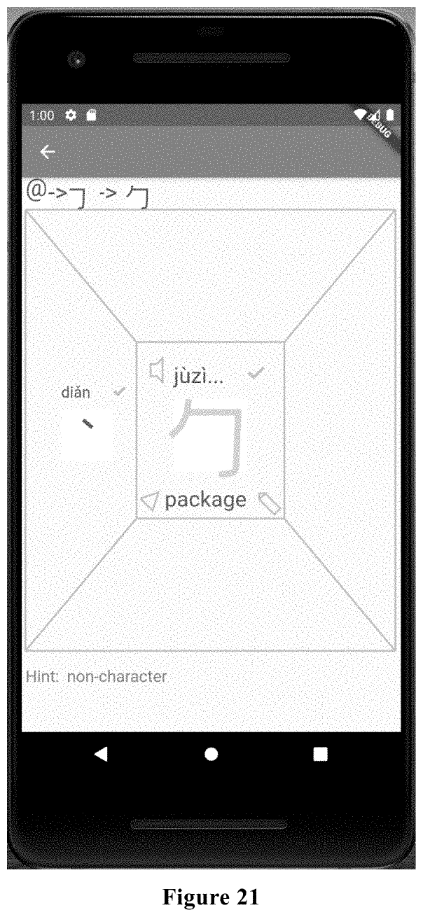

FIG. 21 is a schematic diagram of auxiliary symbols and functions of Chinese characters or Basic Components according to an embodiment of the present invention. The literacy interface of the embodiment of the present invention also provides four auxiliary symbols and functions for learning Chinese characters or Basic Components. As shown in FIG. 21, the upper left corner of the central area in FIG. 21 is a pronunciation symbol (that is, an example of a pronunciation control). Clicking on the pronunciation symbol will emit the pronunciation of the character or Basic Component (ie, audio information). The upper right corner of the central area in FIG. 21 is the learned symbol. If the user has just learned the character and then switches from another literacy interface to the character literacy interface, the symbol will appear to remind the user that the Chinese character has been learned. The learned symbol can also be used to mark characters or Basic Components in the four sub-areas of the surrounding area, expressing the same meaning, and the marked characters or Basic Components have been learned. The lower right corner of the central area of FIG. 21 is an animation symbol. Clicking on the symbol will draw the character or Basic Component in an animated manner. If it is a Basic Component (character-forming component and non-character component), draw its strokes; if it is a multi-component Chinese character, all components of the character will be displayed in the order of the components at a preset time interval (the time interval is set according to needs, usually the interval is very short). The lower left corner of the central area of FIG. 21 is a symbol for new character. If the character has never appeared before, the new character symbol is displayed to inform the user that the character is a character that has not appeared before.

It should be noted that the layout of the auxiliary symbols (including pronunciation symbol, learned symbol, animation symbol, and new character symbol) in the literacy interface shown in FIG. 21 is not limited to that shown in FIG. 21, and other layout forms can also be used as needed. For layout, the types and numbers of auxiliary symbols are not limited to those listed in FIG. 21, and the types and numbers of auxiliary symbols can be increased or decreased as needed. Users can directly click the components or characters in the path on the FIG. 21, “@-> [symbol] ”, the system will display an interface centered on the component or character. The symbol “@” represents the top-level interface.

The literacy method of the embodiment of the present invention is based on the formation of Basic Component character-forming/non-character code. Starting from the Basic Components of Chinese characters, it learns Chinese characters layer by layer in four directions, and realizes a simple and efficient multi-layer planar Chinese character linear literacy system. A central frame (that is, the central area) plus a border in 4 directions (that is, the four sub-areas of the surrounding area) to express the positional relationship of the Chinese character components gradually derived from simplified to complex in four directions, and provides a literacy interface. Add a Basic Component or character to a character, and then synthesize the logical relationship and display method of each layer of a new character. Use a simple, same-layout literacy interface for multi-level use to express the derivative relationship of the characters. When the user selects the border, the characters in the literacy interface of the present invention can be used to express the logical relationship of Chinese characters simply and practically. In addition, the shape, sound and meaning of the character can be expressed efficiently and in multiple layers in the character literacy system of the embodiment of the present invention.

The embodiment of the present invention takes the Basic Components of Chinese characters as a starting point, and leads students to learn their shapes, sounds, meanings, and logic along the trajectory generated by more than four thousand commonly used characters. In line with standards and directions, the entire system using two-letter Literacy Codes is complete and scientific, and the user interface is simple and easy to use, and supports the learning of simplified and traditional characters at the same time. It helps students learn and use Chinese characters and Chinese efficiently, and reduces the difficulty of learning Chinese characters.

The literacy system of the embodiment of the present invention can be used in various terminal devices, and can also be applied to the limited screen size of mobile terminals such as mobile phones (for example, Apple phones, Android phones, etc.).

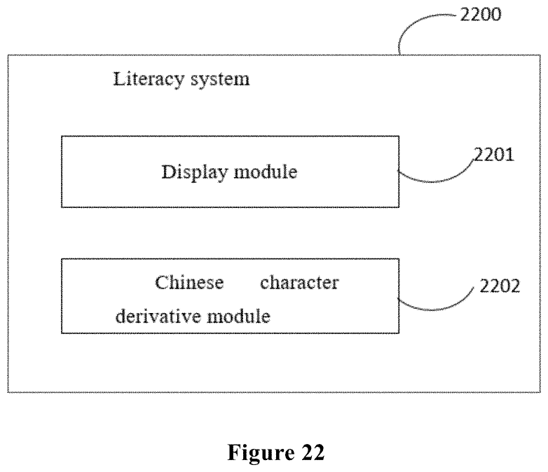

FIG. 22 is a schematic diagram of main modules of a literacy system according to an embodiment of the present invention.

As shown in FIG. 22, the character literacy system 2200 of an embodiment of the present invention mainly includes: a display module 2201 and a Chinese character derivation module 2202.

The display module 2201 is configured to display the target literacy interface under a preset trigger condition, the target literacy interface includes the main Basic Component or the main Chinese character, and also includes one or more first literacy prompt messages;

The display module 2201 is also used to display the designated literacy interface of the next-level of the target literacy interface corresponding to the first literacy prompt information selected by the user after receiving the user's selection instruction for the first literacy prompt information on the target literacy interface. The main Chinese character in the designated literacy interface is derived by the Chinese character derivation module 2202 from the main Basic Component or the main Chinese character in the target literacy interface.

In the case where there is an upper-level literacy interface in the target literacy interface, the target literacy interface includes the main Chinese character; in the case that the target literacy interface does not have a upper-level literacy interface, the upper-level interface of the target literacy interface is Basic Component selection interface, the target literacy interface includes the main Basic Component.

In one embodiment, the main Basic Component in the target literacy interface is a character-forming component or a non-character component, and the character-forming component is itself a character, non-character component is not a character itself. The Basic Component selection interface includes a primary selection interface and a jump selection interface. The primary selection interface is used to select each component that represents a category of character-forming components or non-character components. The jump selection interface is used to display all of the character-forming components or non-character components from the component category in which the selected Basic Component is located.

The primary selection interface may include character-forming components representing each character-forming component category and preset symbol. The preset symbol represents all non-character component categories. When the preset symbol is selected, through the primary selection interface, the sub-interface displays all non-character components representing the categories of non-character components. When a non-character component in the sub-interface is selected, a jump selection interface is used to display all the non-character components from the category in which the selected non-character component is located in the Basic Component sub-interface.

The preset trigger condition may be: an upper-level literacy interface exists in the target literacy interface, and in the upper-level literacy interface of the target literacy interface, the second literacy prompt information corresponding to the target literacy interface is selected.

The preset trigger condition can be: there is no upper-level literacy interface in the target literacy interface, and identical Basic Component in the Basic Component selection interface with the main Basic Component in the target literacy interface is selected.

The preset trigger condition can be: the main Basic Component or the main Chinese character in the target literacy interface match the content entered by the user.

The preset trigger condition may be: the main Chinese character of a literacy interface that is the same as or different from the designated literacy interface in the next-level literacy interface of the target literacy interface is selected.

In one embodiment, the first literacy prompt information is a Chinese character component or a Chinese character, and the Chinese character component is based on one or more Basic Components obtained, the Chinese character derivation module 2202 combines the Chinese character components or Chinese characters with the main Basic Components or the main Chinese characters in the target literacy interface to derive the main Chinese characters in the next-level literacy interface of the target literacy interface.

In another embodiment, the first literacy prompt information is the same Chinese character as the main Chinese character in the next-level literacy interface of the target literacy interface.

In one embodiment, the main Basic Component or the main Chinese character in the target literacy interface is located in the central area of the specific space in the target literacy interface, and the first literacy prompt information is located in the peripheral area of the specific space in the target literacy interface.

The peripheral area of the target literacy interface may include four sub-areas located in the upper, lower, left, and right directions of the central area in the target literacy interface, and the direction of any sub-area relative to the central area in the target literacy interface, when the main Chinese character in the specific literacy interface at the next-level of the derived target literacy interface is indicated, on the direction in which Chinese character component or Chinese character is added to the main component or the main Chinese character, the next-level specific literacy interface is the next-level literacy interface of the target literacy interface corresponding to the first literacy prompt information in the sub-area.

The target literacy interface may also include a display area for the character information, and the character information display area is used to display the character information of the main Chinese character in the target literacy interface.

The display area of the character information can be located outside the specific space in the target literacy interface.

The target literacy interface may also include one or more of the display areas of the meaning information, the display area of the phonetic information, and the display area of the pronunciation control. The display area of the meaning information and the display area of the phonetic information are respectively used to display the meaning information and phonetic information of the main Chinese characters in the target literacy interface. The system also includes a pronunciation module. The pronunciation module is used to issue the audio information corresponding to the main Basic Component or the main Chinese character in the target literacy interface when the pronunciation control is selected.

One or more of the display areas of the meaning information, the display area of the phonetic information, and the display area of the pronunciation control may be located in the central area of the target literacy interface.

The literacy system 2200 of the embodiment of the present invention may further include a storage module for storing a Literacy Code table, and determine the hierarchical relationship between each level of literacy interfaces according to the derivative relationship of Chinese characters recorded in the Literacy Code table, where the Literacy Code table records Basic Components, Chinese characters and the corresponding character identifier, and each Basic Component or Chinese character has its own layer. The derivation relationship of Chinese characters is indicated by the character identifier of each Chinese character in the Literacy Code table and the corresponding character identifier of the upper-layer. The character identifier of the upper-layer of the Chinese character is derived from the Chinese character Basic Components, the character identifier of the Chinese character or the character identifier of other Chinese characters derived from the Chinese character. The Literacy Code table records the character identifier of each Chinese character derived from other Chinese characters.

The literacy system 2200 of the embodiment of the present invention may further include a Literacy Code table generating module, which is used to generate a Literacy Code table according to the derivative relationship of Chinese characters in the main path of Chinese character literacy, wherein the main path of a target Chinese character is determined by the following method: The target Chinese characters are gradually split according to the structure of the Chinese characters. Among them, the main path character is selected from the splitting results of each step, and the main path character is used for the next splitting until the splitting result of the last step is obtained. The main path characters of the last level are selected from the splitting results; the target Chinese characters and the main path characters selected during the splitting process at all levels are selected in the reverse order of the splitting order to generate the main path of literacy of the target Chinese characters.

When selecting the main path characters based on the splitting results of each step, you can select them according to the following priority order: Firstly select Chinese characters or character-forming components from the splitting results as the main path characters; if the splitting results include more than one Chinese character or character-forming component, the one that is the same or similar to the pronunciation of the Chinese character before the split is used as the main path character; if the split result is the Chinese character or the character that is the same or similar in pronunciation to the Chinese character before the split, if there is more than one character-forming component, the multi-component character in the split result is used as the main path character, and the multi-component character includes multiple Basic Components. If there is more than one multi-component character in the splitting result, the multi-component character located on the right, bottom or inside of the Chinese character before splitting in the splitting result will be used as the main path character.

The Literacy Code table can also record the direction of each Chinese character from the upper-level Basic Component adding Chinese character or Basic Component, or the direction from the upper-level Chinese character adding Basic Component or Chinese character.

The display module 2201 can also be used to determine the sub-area of the target literacy interface corresponding to the prompt information of the Chinese character or Chinese character component according to the direction of adding Chinese character or Basic Component in the Literacy Code table. The Chinese character component is based on one or more Basic Components.

The Literacy Code table can also record each Basic Component according to the Literacy Code corresponding to each Chinese character, the display module 2201 is also used to determine the Chinese character or Chinese character component as the literacy prompt information according to the Literacy Code.

The literacy system 2200 of the embodiment of the present invention may also include a Literacy Code generation module, which is used to: for Basic Components (based on the table of Basic Components shown in FIG. 2, all the Basic Components of Chinese characters can be obtained), first, they are divided into two groups according to the character-forming components and non-character components, and then classified according to the shape, and according to the set arrangement rules to arrange Basic Components, using different first type of letters to represent each Basic Component category, Basic Components within each Basic Component category are represented by different second type of letters. The Literacy Code is the combination of the first type of letters for the category and the second type of letters for specific Basic Component.

All Chinese character Basic Components can include Chinese character Basic Components used to generate simplified characters, traditional characters, Chinese characters in Japanese, and Chinese characters in Korean.

In the case that the target literacy interface includes the main Chinese character, when the main Chinese character in the target literacy interface has a phrase it owns, the target literacy interface also includes a prompt; the display module 2201 is also used to: receive a prompt from the user on the target literacy interface after the selection instruction, the phrase interface corresponding to the main Chinese character of the target literacy interface is displayed. The main Chinese characters included in the phrase interface are the same as the main Chinese characters in the target literacy interface. The phrase grouping interface also includes Chinese characters that can group with the main Chinese character to form phrases. In the case that one of the Chinese characters that can be grouped with the main Chinese character of the phrase interface is selected, the phrase interface where the phrase composed of the selected Chinese character and the main Chinese character of the grouping interface is displayed.

The prompt can be located in the surrounding area of the target literacy interface.

In one embodiment, the phrase interface and the charactering interface respectively have the same layout as the target literacy interface, and the Chinese characters that can group characters with the main Chinese character of the phrase interface are located in the peripheral area of the phrase interface.

The character recognition system 2200 of the embodiment of the present invention may further include a phrase table search module for determining Chinese characters that can be grouped with the main Chinese character of the phrase interface according to the phrase table. The phrase table records the correspondence between Chinese characters and phrases.

The layout of the literacy interface at different levels is the same.

In addition, the specific implementation content of the literacy system in the embodiment of the present invention has been described in detail in the above literacy method, so the repeated content will not be described here.

An embodiment of the present invention also provides a terminal device, which includes the literacy system of the embodiment of the present invention. For the introduction of terminal equipment, please refer to the introduction of literacy methods and literacy systems above.

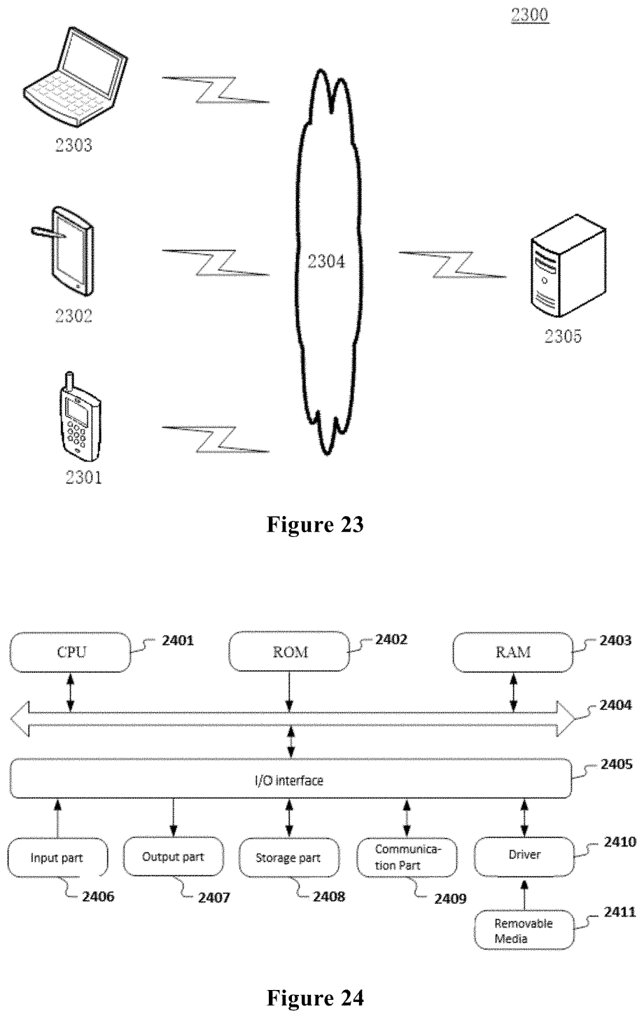

FIG. 23 shows an exemplary system architecture 2300 of a literacy method or literacy system to which an embodiment of the present invention can be applied.

As shown in FIG. 23, the system architecture 2300 may include terminal devices 2301, 2302, 2303, a network 2304, and a server 2305. The network 2304 is used to provide a communication link medium between the terminal devices 2301, 2302, 2303 and the server 2305. The network 2304 may include various connection types, such as wired, wireless communication links, or fiber optic cables, and so on.

The user can use the terminal device 2301, 2302, 2303 to interact with the server 2305 through the network 2304 to receive or send messages and so on. Various communication client applications may be installed on the terminal devices 2301, 2302, 2303, such as shopping applications, web browser applications, search applications, instant messaging tools, email clients, social platform software, etc. (only examples).

The terminal devices 2301, 2302, 2303 may be various electronic devices that have a display screen and support web browsing, including but not limited to smart phones, tablet computers, laptop computers, desktop computers, and so on.

The server 2305 may be a server that provides various services, such as a back-end management server (just an example) that provides support for shopping websites browsed by users using the terminal devices 2301, 2302, and 2303. The background management server can analyze and process the received product information query request and other data, and feedback the processing results (such as target push information, product information-only examples) to the terminal device.

It should be noted that the literacy method provided by the embodiment of the present invention is generally executed by the terminal devices 2301, 2302, 2303, and correspondingly, the literacy system is generally set in the terminal devices 2301, 2302, 2303.

It should be understood that the numbers of terminal devices, networks, and servers in FIG. 23 are merely illustrative. According to implementation needs, there can be any number of terminal devices, networks, and servers.

Referring now to FIG. 24, it shows a schematic structural diagram of a computer system 2400 suitable for implementing a terminal device according to an embodiment of the present application. The terminal device shown in FIG. 24 is only an example, and should not bring any limitation to the functions and scope of use of the embodiments of the present application.

As shown in FIG. 24, the computer system 2400 includes a central processing unit (CPU) 2401, which can follow a program stored in a read-only memory (ROM) 2402 or a program loaded from a storage part 2408 to a random access memory (RAM) 2403. And perform various appropriate actions and processing. In the RAM 2403, various programs and data required for the operation of the system 2400 are also stored. The CPU 2401, the ROM 2402, and the RAM 2403 are connected to each other through a bus 2404. An input/output (I/O) interface 2405 is also connected to the bus 2404.

The following components are connected to the I/O interface 2405: an input part 2406 including a keyboard, a mouse, etc.; an output part 2407 including a cathode ray tube (CRT), a liquid crystal display (LCD), etc., and speakers, etc.; a storage part 2408 including a hard disk, etc.; and a communication part 2409 including a network interface card such as a LAN card, a modem, and the like. The communication section 2409 performs communication processing via a network such as the Internet. The driver 2410 is also connected to the I/O interface 2405 as needed. A removable medium 2411, such as a magnetic disk, an optical disk, a magneto-optical disk, a semiconductor memory, etc., is installed on the drive 2410 as needed, so that the computer program read from it is installed into the storage part 2408 as needed.

In particular, according to the disclosed embodiments of the present invention, the process described above with reference to the flowchart can be implemented as a computer software program. For example, the disclosed embodiments of the present invention include a computer program product, which includes a computer program carried on a computer-readable medium, and the computer program contains program code for executing the method shown in the flowchart. In such an embodiment, the computer program may be downloaded and installed from the network through the communication part 2409, and/or installed from the removable medium 2411. When the computer program is executed by the central processing unit (CPU) 2401, it executes the above-mentioned functions defined in the system of the present application.

It should be noted that the computer-readable medium shown in the present invention may be a computer-readable signal medium or a computer-readable storage medium, or any combination of the two. The computer-readable storage medium may be, for example, but not limited to, an electrical, magnetic, optical, electromagnetic, infrared, or semiconductor system, device, or device, or a combination of any of the above. More specific examples of computer-readable storage media may include, but are not limited to: electrical connections with one or more wires, portable computer disks, hard disks, random access memory (RAM), read-only memory (ROM), erasable programmable read-only memory (EPROM or flash memory), optical fiber, portable compact disk read-only memory (CD-ROM), optical storage device, magnetic storage device, or any suitable combination of the above. In this application, the computer-readable storage medium may be any tangible medium that contains or stores a program, and the program may be used by or in combination with an instruction execution system, apparatus, or device. In this application, a computer-readable signal medium may include a data signal propagated in a baseband or as a part of a carrier wave, and a computer-readable program code is carried therein. This propagated data signal can take many forms, including but not limited to electromagnetic signals, optical signals, or any suitable combination of the foregoing. The computer-readable signal medium may also be any computer-readable medium other than a computer-readable storage medium. The computer-readable medium may send, propagate, or transmit the program for use by or in combination with the instruction execution system, apparatus, or device. The program code contained on the computer-readable medium can be transmitted by any suitable medium, including but not limited to: wireless, wire, optical cable, RF, etc., or any suitable combination of the above.

The flowcharts and block diagrams in the accompanying drawings illustrate the possible implementation of the system architecture, functions, and operations of the system, method, and computer program product according to various embodiments of the present application. In this regard, each block in the flowchart or block diagram can represent a module, program segment, or part of code, and the above-mentioned module, program segment, or part of code contains one or more for realizing the specified executable instructions of logic function. It should also be noted that, in some alternative implementations, the functions marked in the block may also occur in a different order from the order marked in the drawings. For example, two blocks shown in succession can actually be executed substantially in parallel, and they can sometimes be executed in the reverse order, depending on the functions involved. It should also be noted that each block in the block diagram or flowchart, and the combination of blocks in the block diagram or flowchart, can be implemented by a dedicated hardware-based system that performs the specified functions or operations, or can be realized by a combination of dedicated hardware and computer instructions.

The modules involved in the embodiments described in the present invention can be implemented in software or hardware. The described module can also be set in the processor, for example, it can be described as: a processor includes a display module and a Chinese character derivative module. Wherein, the names of these modules do not constitute a limitation on the module itself under certain circumstances. For example, the display module can also be described as “a module for displaying a target literacy interface under a preset trigger condition.”

As another aspect, the present invention also provides a computer-readable medium. The computer-readable medium may be included in the device described in the above embodiment; or it may exist alone without being assembled into the device. The above-mentioned computer-readable medium carries one or more programs. When the above-mentioned one or more programs are executed by a device, the device includes: an interface that displays a target literacy under a preset trigger condition, and the target literacy interface includes main Basic Components or the main Chinese character, further including one or more first literacy prompt information; after the target literacy interface receives a user's selection instruction for the first literacy prompt information, the first literacy prompt information selected by the user is displayed corresponding to the designated literacy interface of the next-level of the target literacy interface, the main Chinese character in the designated literacy interface is derived from the main Chinese character or main Basic Component of the target literacy interface.

According to the technical solution of the embodiment of the present invention, the target literacy interface is displayed under a preset trigger condition, and the target literacy interface includes the main Basic Components or the main Chinese character, which also includes one or more first literacy prompt messages. After the user's selection instruction for the first literacy prompt information is received on the target literacy interface, the target literacy corresponding to the first literacy prompt information selected by the user is displayed under the next-level designated literacy interface, the main Chinese character in the designated literacy interface is derived from the main Basic Component or main Chinese character of the target literacy interface. Able to synthesize the sounds, shapes, and meanings of about 4,000 commonly used Chinese characters from simple to complex, layer by layer, and through the four-direction literacy plane, in the limited size of mobile terminals (such as mobile phones, etc.), the display is demonstrated in a multi-layered plane, so that learners can learn these Chinese characters conveniently while understanding the evolution process and logical relationship of these Chinese characters, so as to achieve the purpose of quickly learning and mastering these Chinese characters, and realizes the steps and methods of systematically learning Chinese characters in a real way, and the formation of a multi-level system from simple to complex. The user interface is simple and easy to use, and supports simplified and traditional characters at the same time. It is suitable for a wide range of use and can be used on mobile terminals such as mobile phones. Display and learn Chinese characters simply and efficiently.

The foregoing specific implementations do not constitute a limitation on the protection scope of the present invention. Those skilled in the art should understand that, depending on design requirements and other factors, various modifications, combinations, sub-combinations, and substitutions can occur. Any modification, equivalent replacement and improvement made within the spirit and principle of the present invention should be included in the protection scope of the present invention.

1. A method of literacy, characterized in that it includes:
Under the preset trigger condition, display the target literacy interface, the target literacy interface includes the main Basic Component or the main Chinese character, which also includes one or more first literacy prompt messages;
After the target literacy interface receives the user's selection instruction for the first literacy prompt information, the designated literacy interface of the next-level of the target literacy interface corresponding to the first literacy prompt information selected by the user is displayed; the main Chinese character in the specified literacy interface is derived from the main Basic Component or the main Chinese character in the target literacy interface.

2. The method of claim 1, wherein:
In the case where there is an upper-level literacy interface in the target literacy interface, the target literacy interface includes the main Chinese character;
In the case that there is no upper-level literacy interface in the target literacy interface, the upper-level interface of the target literacy interface is a Basic Component selection interface, and the target literacy interface includes the main Basic Component.

3. The method according to claim 2, wherein the main Basic Component in the target literacy interface is a character-forming component or a non-character component, the character-forming component is itself a Chinese character, the non-character component is not a Chinese character itself, the said Basic Component selection interface includes a primary selection interface and a jump selection interface. The primary selection interface is used to select Basic Components representing the character-forming component categories and the non-character component categories. The Basic Component jump selection interface is used to display all of Basic Components of the selected character-forming component category or non-character component category.

4. The method according to claim 3, wherein the primary selection interface includes character-forming components representing each of the character-forming component categories and a preset symbol, and the preset symbol indicates non-character components representing all non-character component categories; when the preset symbol is selected, all non-character components representing the non-character component categories are displayed through the sub-interface of the primary selection interface, and in the case a non-character component in the sub-interface is selected, a jump selection interface is used to display all the Basic Components in the category that contains the selected non-character component in the sub-interface.

5. The method according to claim 1, wherein the preset trigger condition is:
There is an upper-level literacy interface in the target literacy interface, and in the upper-level literacy interface of the target literacy interface, the second literacy prompt information corresponding to the target literacy interface is selected.

6. The method according to claim 2, wherein the preset trigger condition is: there is no upper-level literacy interface in the target literacy interface, a Basic Component is selected from Basic Component selection interface which is identical with the main Basic Component in the target literacy interface.

7. The method according to claim 1, wherein the preset trigger condition is:
The main Chinese character of a literacy interface that is the same as or different from the designated literacy interface in the next-level literacy interface of the target literacy interface is selected.

8. The method according to claim 1, wherein the first literacy prompt information is a Chinese character component or a Chinese character, and the Chinese character component is based on one or more Basic Components, by combining the Chinese character component or Chinese character with the main Basic Component or the main Chinese character in the target literacy interface to derive the main Chinese character in the next-level literacy interface of the target literacy interface.

9. The method according to claim 1, wherein the first literacy prompt information is the same Chinese character as the main Chinese character in the next-level literacy interface of the target literacy interface.

10. According to the claim 8 or 9, the method is characterized in that the main Basic component or the main Chinese character in the target literacy interface is located in the central area of the specific space in the target literacy interface, and the first literacy prompt information is located in the peripheral area of the specific space in the target literacy interface.

11. According to the claim 10, the method is characterized in that the peripheral area in the target literacy interface includes four sub-areas respectively located in the upper, lower, left, and right directions of the central area in the target literacy interface, the direction of any sub-area relative to the central area in the target literacy interface indicates that when the main Chinese character in the specific literacy interface of the next-level of the target literacy interface is derived, for the direction of the Chinese character component or the Chinese character is added to the main Basic Component or the main Chinese character in the target literacy interface, the next-level specific literacy interface is the next-level literacy interface of the target literacy interface corresponding to the first literacy prompt information in the sub-area.

12. According to the claim 10, the method is characterized in that the target literacy interface further includes a display area of character logic information, and the display area of the character information is used to display the character logic information of the main Chinese character in the target literacy interface, the display area of the character logic information is located outside the specific space in the target literacy interface.

13. According to the claim 10, the method is characterized in that the target literacy interface further includes one or more of the display area of the meaning information, the display area of the phonetic information, and the display area of the pronunciation control, and the display area of the meaning information, the display area of phonetic information is respectively used to display the meaning information and phonetic information of the main Chinese character in the target literacy interface. When the pronunciation control is selected, the audio information corresponding to the main Basic Component or the main Chinese character in the target literacy interface is produced. One or more of the display area of the character meaning information, the display area of the phonetic information, and the display area of the pronunciation control are located in the central area of the target literacy interface.

14. According to the claim 11, the method is characterized in that the hierarchical relationship between each level of literacy interface is determined according to the derivative relationship of Chinese characters recorded in the Literacy Code table, wherein the Literacy Code table records Basic Components, Chinese characters and the corresponding character identifier, and each Basic component or Chinese character is located in a layer, the derivation of the Chinese character is represented by the character identifier of each Chinese character in the Literacy Code table and the corresponding character identifier of the upper-layer, and the character identifier of the upper-layer of the Chinese character is the character identifier of the Basic Component or the Chinese character that this Chinese character is derived from, and the Literacy Code table records the upper-level character identifier of each Chinese character derived from other Chinese characters.

15. According to the claim 14, the method is characterized in that the Literacy Code table is generated according to the Chinese character derivation relationship in the main path of Chinese character literacy, wherein the main path of a target Chinese character literacy is determined in the following manner:
The target Chinese characters are gradually split according to the structure of the Chinese characters. Among them, the main path character is selected from the splitting results of each step, and the main path character is used for the next splitting until the final splitting result is obtained. Select the main path character of the last level from the split result of the last step;
The target Chinese character and the main path characters of each level selected in the splitting process are generated according to the reverse order of the splitting order to generate the main literacy path of the target Chinese character.

16. According to the claim 15, the method is characterized in that when the main path character is selected based on the split result of each step, the selection is performed according to the following priority order:
First select Chinese characters or character-forming components from the split result as the main path characters;
If there is more than one Chinese character or character-forming component in the splitting result, the Chinese character or character-forming component in the splitting result that has the same or similar pronunciation as the Chinese character before splitting is used as the main path character;
If there is more than one Chinese character or character-forming component that has the same or similar pronunciation as the Chinese character before the split in the splitting result, the multi-component character in the splitting result is used as the main path character, and the multi-component character is Chinese character with multiple Basic Components.
If there is more than one multi-component character in the splitting result, the multi-component character located on the right, bottom or inside of the Chinese character before splitting in the splitting result is used as the main path character.

17. According to the claim 14, the method is characterized in that the Literacy Code table also records the direction of each Chinese character is created by upper-level Basic Component or Chinese character adding to a Basic Component, or the direction of each Chinese character is created by upper-level Basic Component or Chinese character adding to a Chinese character.

18. According to the claim 17, the method is characterized in that according to the direction of adding Chinese characters or adding Basic Components recorded in the Literacy Code table, the sub-area of the literacy interface corresponding to Chinese character or Chinese character component as the literacy prompt information is determined, and the Chinese character component is based on one or more Basic Components.

19. According to the claim 18 the method is characterized in that the Literacy Code table also records the Literacy Code corresponding to each Basic component and each Chinese character, the Chinese character or Chinese character component as the literacy prompt information is determined according to the Literacy Code.

20. According to the claim 19, the method is characterized in that it further includes:
All Basic Components are divided into two groups first according to character-forming components and non-character components. Then classify according to the shape, and arrange Basic Components according to the set arrangement rules, using different first type of alphabets to represent each Basic Component category, each Basic Component in each Basic Component category is represented by different second type of alphabets. The Literacy Code of each Basic Component is a combination of the first type of alphabets and the second type of alphabets of the Basic Component in the category.

21. According to the claim 20, the method is characterized in that all the Basic Components include Basic Components for generating simplified characters, traditional characters, Chinese characters in Japanese, and Chinese characters in Korean.

22. According to the claim 10, the method is characterized in that, in the case that the target literacy interface includes the main Chinese character, when the main Chinese character in the target literacy interface owns a phrase, the target literacy interface further includes a prompt;
After the target literacy interface receives the user's selection instruction for the prompt, it displays a phrase interface corresponding to the main Chinese character of the target literacy interface, and the main Chinese character included in the phrase interface and the target literacy interface are the same, and the phrase interface also includes Chinese characters that can group characters with the main Chinese characters of the phrase interface;
In the case where one of the Chinese characters that can be grouped with the main Chinese character of the phrase interface is selected, the phrase interface where the phrase formed by the selected Chinese character and the main Chinese character of the phrase interface is located is displayed.

23. According to the claim 22, the method is characterized in that the prompt is located in the peripheral area of the target literacy interface, the phrase interface and the character interface are respectively the same in layout as the target literacy interface, the Chinese characters that can be grouped with the main Chinese characters are displayed in the surrounding area in the phrase interface, and the phrase table determines which Chinese characters can create phrases with the main Chinese character in the target phrase interface, and the corresponding relationship between the Chinese characters and the phrase is recorded in the phrase table.

24. The method according to claim 1, wherein the layout of the literacy interface at different levels is the same.

25. A literacy system, which is characterized by comprising: a display module and a Chinese character derivative module, wherein:
The display module is configured to display a target literacy interface under a preset trigger condition, and the target literacy interface includes a main Basic Component or a main Chinese character, and also includes one or more first literacy prompt messages;
The display module is further configured to display the next target literacy interface corresponding to the first literacy prompt information selected by the user after the target literacy interface receives a user's selection instruction for the first literacy prompt information. The main Chinese character in the designated literacy interface is derived from the main Basic Component or the main Chinese character of the target literacy interface in the Chinese character derivative module.

26. A terminal device, characterized by comprising: the literacy system of claim 25.

27. An electronic device, characterized in that it comprises:
One or more processors;
Memory, used to store one or more programs;
When the one or more programs are executed by the one or more processors, the one or more processors are caused to implement claims as claimed in any claim 1-24 of the methods described in.

28. A computer-readable medium with a computer program stored thereon, wherein the computer program is executed by a processor to achieve any claim 1-24 of the methods described in.
